(19) United States
(12) Patent Application Publication
(10) Pub. No.: US 2021/0065356 A1
(43) Pub. Date: Mar. 4, 2021

(54) APPARATUS AND METHOD FOR HEAT EXCHANGER INSPECTION

(71) Applicant: BWXT Nuclear Energy, Inc., Lynchburg, VA (US)

(72) Inventors: Benjamin D. Fisher, Lynchburg, VA (US); Nicholas Johnson, Chattanooga, TN (US)

(21) Appl. No.: 16/557,704

(22) Filed: Aug. 30, 2019

(51) Int. Cl. G06T 7/00; F28F 19/00; G06T 7/30; G06T 7/60

(52) U.S. Cl. CPC G06T 7/0004; F28F 19/00; F01D 25/007; G06T 7/60; G06T 7/30

(57) ABSTRACT

A robot for heat exchanger inspection is provided including a mobility system configured to move the robot in reference to the heat exchanger, a camera configured to capture image data including at least a portion of the heat exchanger, and processing circuitry. The processing circuitry is configured to receive the image data from the camera, determine a plurality of heat exchanger characteristics in the image data, compare the heat exchanger characteristics to heat exchanger data, determine a current location and an orientation angle of the robot based on the comparison of the one or more heat exchanger characteristics to the heat exchanger data, identify the heat exchanger characteristic based on the current location, determine an orientation angle of the robot, and determine an end effector position based on the current location and the orientation angle.

### TECHNICAL FIELD

Example embodiments generally relate to heat exchangers and, in particular, relate to heat exchanger inspections.

### BACKGROUND

Heat exchangers, such as steam generators, may be periodically inspected to identify degradation between a heat source side and a heat sink side of the heat exchanger. A heated fluid may flow through a tube sheet and a plurality of tubes that maximize a heat transfer area to a fluid on the heat sink side. These tubes and the tube sheet may be susceptible to corrosion and chemical build up due to their geometry. Heat exchangers may be inspected to detect and address corrosion and chemical build up, thereby extending the heat exchanger's lifetime and preventing leaks from the heat source side to the heat sink side.

### BRIEF SUMMARY OF SOME EXAMPLES

Accordingly, some example embodiments may enable heat exchanger inspection, as described below. In one example embodiment, a robot for heat exchanger inspection is provided including a mobility system configured to move the robot in reference to the heat exchanger, a camera configured to capture image data including at least a portion of the heat exchanger, and processing circuitry. The processing circuitry is configured to receive the image data from the camera, determine a plurality of heat exchanger characteristics in the image data, compare the plurality of heat exchanger characteristics to heat exchanger data, determine a current location and an orientation angle of the robot based on the comparison of the plurality of heat exchanger characteristics to the heat exchanger data, identify the plurality of heat exchanger characteristic based on the current location, adjust the orientation angle based on a calculation of a plurality of angles between the plurality of heat exchanger characteristics, and determined an end effector position based on the current location and the orientation angle.

In another example embodiment, an apparatus for heat exchanger inspections is provided including processing circuitry. The processing circuitry is configured to receive the image data from a camera associated with a robot, determine a plurality of heat exchanger characteristics in the image data, compare the plurality of heat exchanger characteristics to heat exchanger data, determine a current location and an orientation angle of the robot based on the comparison of the plurality of heat exchanger characteristics to the heat exchanger data, identify the plurality of heat exchanger characteristic based on the current location, adjust the orientation angle based on a calculation of a plurality of angles between the plurality of heat exchanger characteristics, and determine an end effector position based on the current location and the orientation angle.

### BRIEF DESCRIPTION OF THE SEVERAL VIEWS OF THE DRAWING(S)

Having thus described the heat exchanger inspection in general terms, reference will now be made to the accompanying drawings, which are not necessarily drawn to scale, and wherein:

FIG. 1 is a schematic illustration of an example heat exchanger for use with a robot and method according to an example embodiment;

Each of FIGS. 2A and 2B is a perspective view of a robot for heat exchanger inspection according to an example embodiment;

FIG. 3A illustrates example image data acquired by a robot as in FIGS. 2A and 2B at a heat exchanger as in FIG. 1;

FIG. 3B illustrates an example flattened image data as in FIG. 3A;

FIG. 4A illustrates example light-compensated image data acquired by a robot as in FIGS. 2A and 2B at a heat exchanger as in FIG. 1;

FIG. 4B illustrates example light-compensated flattened image data as in FIG. 4A;

FIG. 5 is a schematic illustration of heat exchanger characteristic and angle determination according to a method of an example embodiment;

FIG. 6A is a graphical illustration of heat exchanger data according to a method of an example embodiment;

FIG. 6B is a schematic illustration of an image acquired by a robot as in FIGS. 2A and 2B and of an end effector position and offset according to an example embodiment;

FIG. 7 illustrates an example image data of a tube sheet including a stay tube for use with a robot and method according to an example embodiment;

FIG. 8 illustrates an example image data of a tube sheet including a plug tube for use with a robot and method according to an example embodiment;

FIG. 9 illustrates an example tube sheet including identified heat exchanger characteristics for use with a robot and method according to an example embodiment;

FIG. 10 illustrates an example robot for heat exchanger inspection according to an example embodiment;

FIGS. 11 and 12 illustrate example embodiments of heat exchanger tubes for use with a method according to an example embodiment;

Each of FIGS. 13A and 13B is a perspective illustration of example embodiments of heat exchanger tubes and a tube sheet for use with a method according to an example embodiment;

FIG. 14 is a schematic illustration of a computer system for use within a heat exchanger inspection system and method according to an example embodiment;

FIG. 15 is a flow chart illustration and a heat exchanger inspection according to an example embodiment.

### DETAILED DESCRIPTION

Some example embodiments now will be described more fully hereinafter with reference to the accompanying drawings, in which some, but not all, example embodiments are shown. Indeed, the examples described and pictured herein should not be construed as being limiting as to the scope, applicability or configuration of the present disclosure. It will be apparent to those skilled in the art that modifications and variations can be made in such example embodiments without departing from the scope or spirit thereof. For instance, features illustrated or described in one embodiment may be used on another embodiment to yield a still further embodiment. Thus, it is intended that the present invention covers such modifications and variations as come within the scope of the appended claims and their equivalents. Like reference numerals refer to like elements throughout.

As used herein, terms referring to a direction or a position relative to the orientation of a robot, such as but not limited to “vertical,” “horizontal,” “above,” or “below,” refer to directions and relative positions with respect to the robot's orientation in its normal intended operation on a tube sheet, as indicated in FIGS. 2A and 2B. In such references, the tube sheet is always considered to be in a horizontal plane, facing upward, so that the robot is always considered to be disposed on and above the tube sheet, and the camera's field of view is always considered to be directed downward, toward the tube sheet. It should be understood, in view of the present disclosure, that such assumption of orientation is for purposes of convenience of explanation and convenience of reference to relative positions and orientations of components of systems described and claimed herein, that, in a larger frame of reference, the tube sheet and robot may be in different orientations, and that the relative orientations described herein are nonetheless applicable.

Further, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be understood to mean “one or more” unless specified otherwise or clear from the context to be directed to a singular form. Throughout the specification and claims, the following terms take at least the meanings explicitly associated therein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment” or other similar phrase, as used herein, does not necessarily refer to the same embodiment, although it may. The phrase “one of A and B” means A or B, not “one of A and one of B.”

In the past, a robotic crawler has been utilized to inspect and/or repair the tube sheet of a heat exchanger. The robotic crawler, e.g. a robot, may include one or more tools, such as an eddy current probe, to test the physical integrity of the tubes. The tools may be coupled to the robot via an arm and end effector. As should be understood, a robotic arm is a projection from the robot, e.g. a metal or rigid plastic bar that the robot may drive over a range of positions, or that may be held rigidly with respect to the remainder of the robot so that the end effector's position changes with the robot's position, to locate an end effector at the arm's end. As should also be understood, an end effector is a device at the end of the arm that is movable under the control of the robot to interact with the robot's environment, e.g. a rotatable gripper (which may grip a tool) or a directly-connected tool. The end effector may be, e.g., a gripper that grips the tool and aligns the tool with the tube sheet or may have an insertion tube that is inserted into the tube sheet tube and through which the tool is inserted into the tube sheet tool. A computer system in communication with the end effector tracked the physical position of the end effector, and correspondingly the tool coupled thereto, with respect to the robot and the tube sheet during the inspection to ensure that the data from the tool or repair work performed was associated with the correct tube.

Generally, robots in the past, e.g. the robot manufactured under the name ZR-100 by Zetec, Inc., of Snoqualmie, Wash., have used a hardware-based (in that computer programming was provided as firmware operable only on dedicated circuitry) position solution to determine the position of the robot and/or end effector/tool by identifying incremental movements of the robot from a known starting location, e.g. a predetermined or manually entered start position and orientation of the robot on the tube sheet, and from prior incremental positions, through analysis of sequential images acquired from a camera located on the robot. The robot may also have included one or more motor encoders that provided data to the computer system so that the computer system, in conjunction with direction data based on a known directional orientation of the robot's mobility system, tracked the robot's change in position based upon the motor encoder's movement, but the camera-based determination of position was independent of the encoder-based determination of position. The robot was initially placed at a predetermined position and orientation in the heat exchanger (e.g. at a predetermined position on the tube sheet), such that the tool on the end effector is aligned with one or more predetermined tubes. For camera-based location, the robot acquired a sequential series of images from a robot-mounted camera as the robot moved across a tube sheet surface. At each image, the robot processor identified circles present in the image and the centers of such circles. Having identified the positions of each identified circle of the immediately previous image in tube sheet space, the processor compared the image-space positions of the circle centers of the present image to the image-space positions of the previous image and, for those present-image centers falling within a predetermined threshold distance of the previous-image centers, identified such present-image centers with the known tube sheet positions of their respective corresponding previous-image centers. By locating multiple centers of the present image in tube sheet space, the processor was then able to locate the positions (in tube sheet space) of any present-image centers that were not paired with a previous-image center through triangulation, assuming each such remaining present-image sensor was within a predetermined threshold of a tube sheet feature center in the tube sheet map.

Having identified the position of all present-image feature centers in tube sheet space (excepting any thereof that failed the threshold test), the processor determined the position of the tool at the end of the end effector. As the end effector was at a fixed position with respect to the robot and, therefore, the camera image center, the processor, having located the present image in tube sheet space, also located the tool position in tube sheet space through triangulation. When the robot thereafter moved and acquired subsequent images, the process repeated, thereby maintaining knowledge of the tool's position as the robot moved over the tube sheet.

As noted, encoder accumulation systems were also known and were used to track the position of the robot and, thereby, the end effector tool. As the robot moved across the tube sheet in response to operator instructions, the computer received data from the encoder(s) that were driven by the motors that drove the robot's movement across the tube sheet and from one or more sensors, e.g. encoders, that outputted data corresponding to the mobility system's direction and updated the robot's/end effector's position and orientation in a tube sheet tracker. Such methods were used independently of the image-based method and could be used, e.g., as a backup confirmation of the result produced by the image-based method.

In another prior system, a robot includes a proximity sensor disposed on the robot so that the proximity sensor is always carried at a predetermined position above the tube sheet surface, such that the sensor switches between two operative states depending whether the sensor is above a solid section of the tube sheet surface or over a tube opening. The processor uses the alternating states to track the robot's position as it moves over the tube sheet.

The prior hardware-based position solutions resulted in only semi-reliable results in the tube sheet tracker. For example, if the end effector was placed in an incorrect initial position, or if the robot moved to an unintended position, the tube sheet tracker correlations could be incorrect, and the inspection results may be correspondingly incorrect from that point on. With regard to image-based tracking, the limited number of tube sheet features, and corresponding centers thereof, gave rise to error in locating the end effector tool position. Further, it could be difficult or impossible to directly verify the robot's/end effector's position outside of the installation area due to dimensional constraints of the heat exchanger.

In some embodiments of systems and methods as described herein, a robot uses a camera and machine vision to capture images of the tube sheet, which may then be presented by a computer system display to an operator for visual analysis and for automatic analysis by the computer system to track and update the robot's position and orientation on the tube sheet. In one or more embodiments, motor encoders are omitted, but in others, motor encoders are used in parallel with machine vision methods. The tube sheet may include hundreds of tube penetrations, which a computer system correlates with tube sheet penetrations in images captured by the robot. The computer system captures and saves these correlations in tracking the robot's movement on the tube sheet, e.g. based on a truth table that maps the tube sheet surface. The computer system uses the correlation of the tube penetrations/openings in the image to the tube penetrations in the tube sheet to determine a position and/or orientation of the robot and associated end effector and/or tool. Particularly, the end effector may be positioned a known distance from the camera in a known direction, such that application of the known distance and direction to the determined position and orientation of the image identifies the end effector's position relative to the tube sheet.

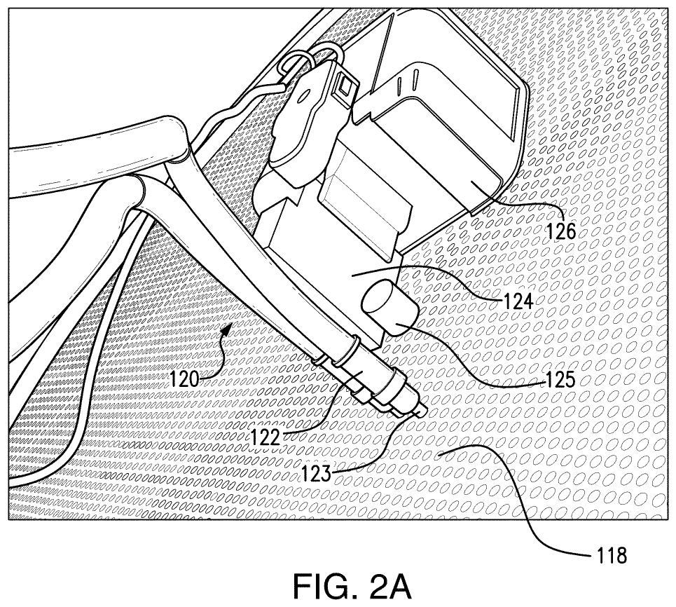

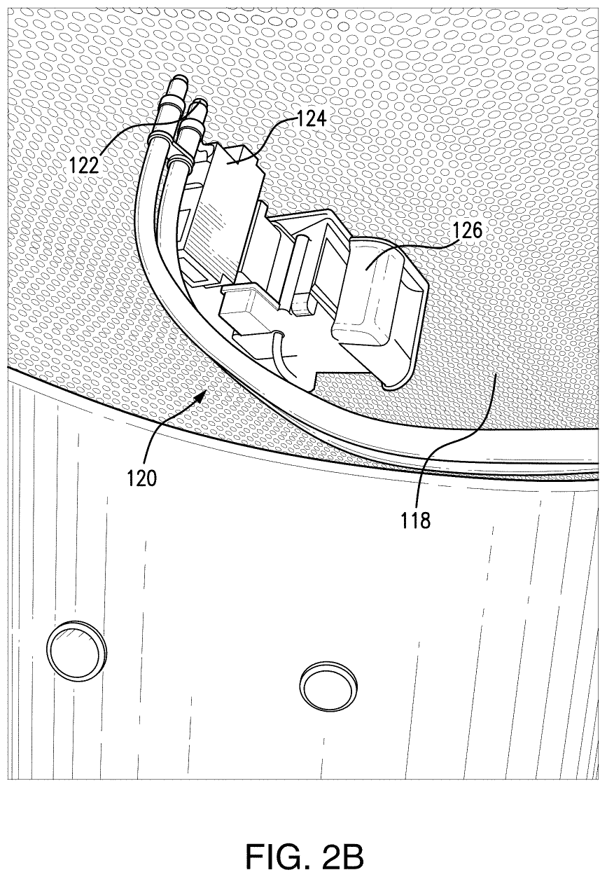

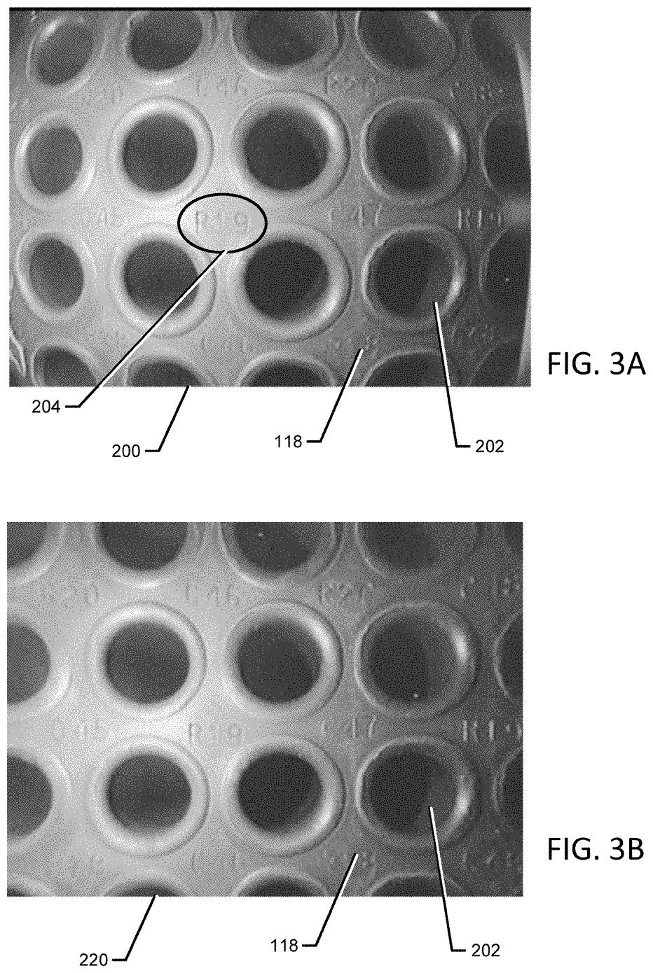

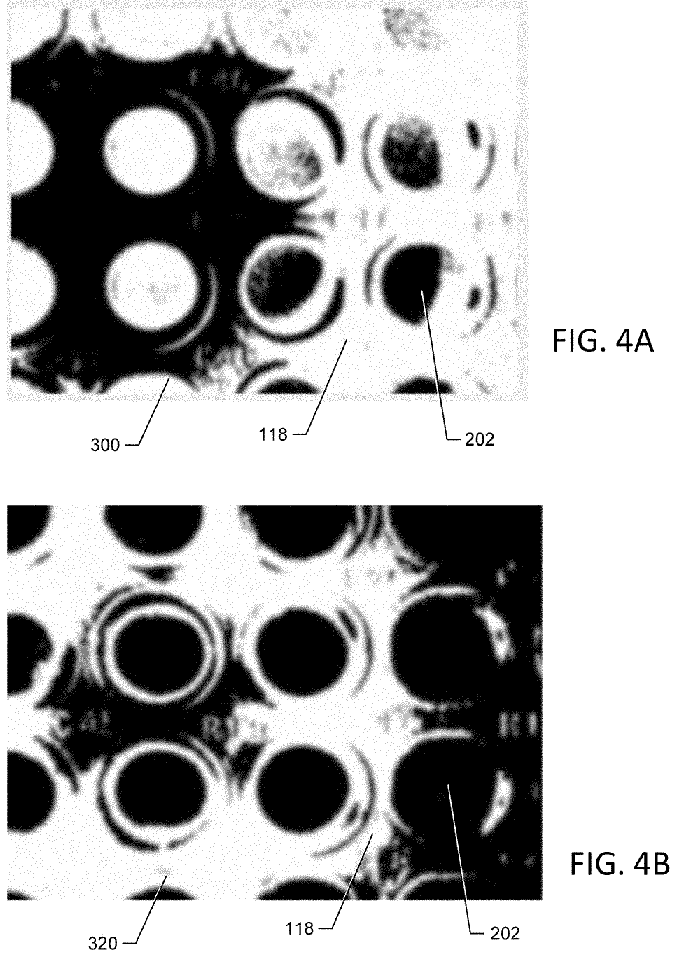

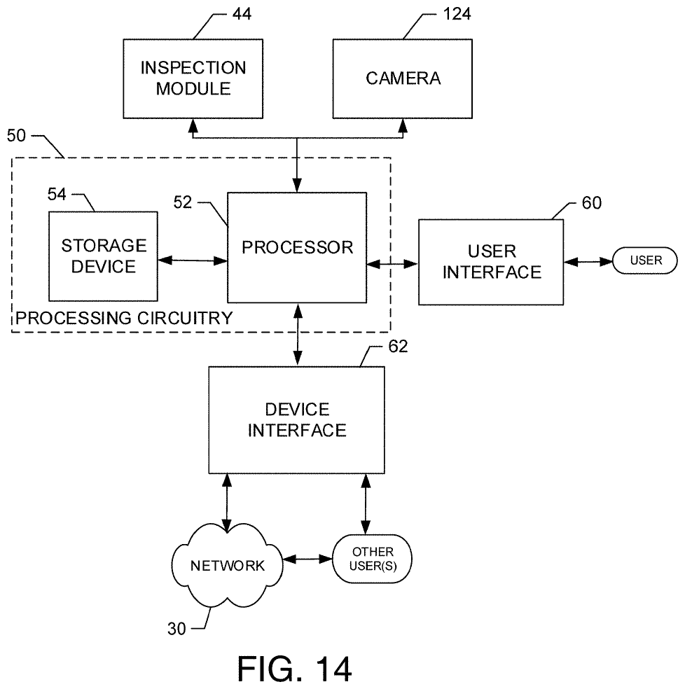

For example, the computer system may initially align the image of the tube sheet surface with a tube sheet map based on two or more tube penetrations or other characteristics that are capable of unique identification in the image and that are also specifically and distinctly identifiable in tube sheet space. As discussed herein, the surface of tube sheet 118 may define a plurality of tube sheet characteristics, such as tube penetration locations 202 (FIGS. 3A-4B), which are represented in the image data 200 (FIGS. 3A-4B) acquired by the robot camera and provided to processing circuitry 50 (FIG. 14) by the camera. For the initial image, the operator interacts with the processing circuitry to identify to the processing circuitry at least two tube openings or other tube sheet features visible in the image. This allows the processing circuitry to correlate the initial image into tube sheet space, thereby allowing the processing circuitry to identify the respective positions in tube sheet space of all or most of the tube sheet features visible in the image. As the operator thereafter moves the robot on the tube sheet surface via remote control, the camera repeatedly acquires images of the tube sheet. The processor analyzes each such subsequent image and, based on knowledge of the tube sheet characteristics from the immediately preceding image, the robot's rate of travel on the tube sheet surface, and the rate at which the robot camera acquires images, identifies in each new image a plurality of tube sheet characteristics previously identified in the immediately preceding image. Thus, in each subsequent image, as in the initial image, the processing circuitry has identified a plurality of tube sheet characteristics for which the processing circuitry knows the respective positions on the tube sheet surface. As in the initial image, the processing circuitry relies upon this information to determine the robot's position and orientation (and, thus, the end effector's/tool's position) on the tube sheet surface. The processing circuitry stores in memory for each image information identifying each identified tube sheet characteristic, the robot's tube sheet location, and the end effector's/tool's tube sheet location (and may, in certain embodiments, also store the image itself in association with such information). This process repeats for each subsequent image, thereby tracking the movement of the robot, end effector, and tool over the tube sheet as the robot moves.

As discussed above, the robot's initial placement may encompass an area such that the initial captured image includes one or more predetermined tube penetrations or other tube sheet characteristics having known positions on the tube sheet surface. The operator, when placing the robot in an initial position on the tube sheet, may do so based upon observation of one or more markers made or placed on the tube sheet in proximity to the predetermined tube sheet characteristics for this purpose. Relying on identification of the predetermined tube sheet characteristics, which the operator identifies in the image through the user interface, the computing system correlates the image-space tube sheet characteristics to tube sheet space, initializing a procedure that is repeatable in each subsequent image frame.

The camera-based position and orientation determination may be limited due to the environmental conditions, such as poor lighting, tight camera clearances, or the like. The limiting conditions may cause the number of tube penetrations which are identifiable in each image to be relatively small, such as three tubes, two tubes, one tube, or, in some instances, zero tubes. The determination of the position and/or orientation on the tube sheet may be limited due to the small number of identifiable tube penetrations. As noted above, in one or more embodiments discussed herein, the processing circuitry may correlate an image into tube sheet space if the processing circuitry identifies at least two tube sheet characteristics in the image that have known positions in tube sheet space. If, in a given image, the processing circuitry is unable to locate at least two known tube sheet characteristics (e.g. because poor lighting prevents identification of tube sheet characteristics or their centers), the processing circuitry discards the image and repeats the process for the next subsequent image, as if the discarded image had not occurred. If the processor is still unable to identify at least two known tube sheet characteristics in the next image, this process repeats and will so repeat until either successfully identifying two known tube sheet characteristics in a subsequent image or assessing a predetermined number of images without identifying two such tube sheet characteristics. The predetermined number is selected by the operator, based on the robot's known top rate of travel on the tube sheet surface and the camera's known rate of image acquisition, to correspond to a distance traveled by the robot at its top speed that would preclude the system from correlating tube sheet characteristics in a new image with tube sheet characteristics in the most recent readable image. At this point, if the robot does not concurrently accumulate its position through the use of motor encoders, the processing circuitry determines that the tracking process cannot continue and provides such notice to the operator at the display of user interface 60 (FIG. 14). In some embodiments, the predetermined number is zero, such that if the robot cannot correlate at least two tube sheet characteristics in any new image, the processor stops tracking and notifies the user, so that recalibration is needed for the robot to continue. If the system does concurrently accumulate its position through the use of motor encoders, the processing circuitry may determine the robot's position and orientation in tube sheet space based on accumulation of motor encoder data, as described above, independently of image-based tracking. In another alternative, the processing circuitry attempts to identify whether tube sheet characteristics that appear in the present image correspond to tube sheet characteristics that the processing circuitry predicts should appear in the image, based on the robot's position as predicted by the encoders. If the processing circuitry so identifies at least two tube sheet characteristics in the image, the processing circuitry determines the robot's orientation based on image data, as described below, and continues to determine position based on image location from that point on, as discussed herein.

The processes for determining the robot's position and orientation in tube sheet space identify those robot characteristics based on the robot camera's center optical position. The end effector, and the tool it secures, are offset from that robot center position by the robot arm, such that error that might occur in the determination of the robot's orientation, for example due to distortion in the image, increase in magnitude when translated out to the tool. Particularly where the tube openings are relatively closely spaced and relatively few tube openings are used to determine the robot's orientation (which can occur, e.g., when using a non-wide angle lens in the camera) so that the tube openings used are relatively close to the camera center, such error can result in a misidentification of the tube to which the tool is applied.

To counter potential effects of such errors, one or more embodiments of apparatus and methods as described herein adjust the determination of the robot's orientation (and, thus, the position of the end effector and its tool) based upon a quantification of distortion present in the image. In particular, the system compares the alignment of certain heat exchanger characteristics (e.g. tube opening centers) with respect to each other in the image with the known alignment of the same heat exchanger characteristics in tube sheet space and, to the extent the comparison indicates that such alignment is distorted in the image, adjusts the determination of the robot's orientation to counteract or accommodate the measured distortion. In certain embodiments, the system bases the distortion measurement upon a first plurality of heat exchanger characteristics visible in the image and a second plurality of heat exchanger characteristics detectable in the image disposed with respect to each other at an expected orientation based on tube sheet space, where confidence in the distortion adjustment increases directly with the number of heat exchanger characteristics in each plurality. The robot and associated processing circuitry may therefore include features to increase the number of detectable heat exchanger characteristics in the image, such as a wide angle lens and image processing techniques that may provide a clearer or more detailed image for determining the heat exchanger characteristics. As should be understood, a non-wide angle, or normal, lens is one that produces a field of view that appears natural to a human observer, i.e. with a focal length approximately equal to or greater than the image frame diagonal. A wide angle lens, by contrast, has a focal length smaller than that of a normal lens for a given film plane, for example less than the approximate image plane diameter or less than half the approximate image plane diameter. The processing circuitry may, for example, apply an undistort filter to the image data to compensate for lens curvature of the wide angle lens. In some embodiments, the processing circuitry may apply light compensation, such as a high and/or low gamma compensation, which may maximize distinguishable details of the image data.

The heat exchanger characteristics may include tube locations, or identification of plugged tubes, stay tubes, or the like, e.g. as identified by the centers thereof. The processing circuitry compares the heat exchanger characteristics from the image to predetermined data locating the characteristic on the tube sheet, to thereby determine the image's current location with respect to the tube sheet map and to identify other tube sheet characteristics in the image with respect to the tube sheet map. The processing circuitry may compare an unknown heat exchanger characteristic, such as a tube location, in a given image to a known heat exchanger characteristic in a prior image to determine or confirm the identity of the heat exchanger characteristic in the present image. In some example embodiments, the processing circuitry may confirm the identity of the heat exchanger characteristic based on two or more image frames at two or more locations.

Turning to the robot's orientation with respect to the tube sheet, the processing circuitry determines a rotation angle of the image, with respect to a given orientation in tube sheet space, based on alignment of the heat exchanger characteristics to the tube sheet map. The processing circuitry then calculates one or more angles between respective pluralities of aligned heat exchanger characteristics, such as tube locations, in image space to determine an offset of heat exchanger characteristics from an expected orientation based on the actual positions of those heat exchanger characteristics in tube sheet space. Relying on this offset, the system adjusts the orientation of the robot and/or camera within a display presented to the operator that identifies the image's location in tube sheet space.

### Example Heat Exchanger

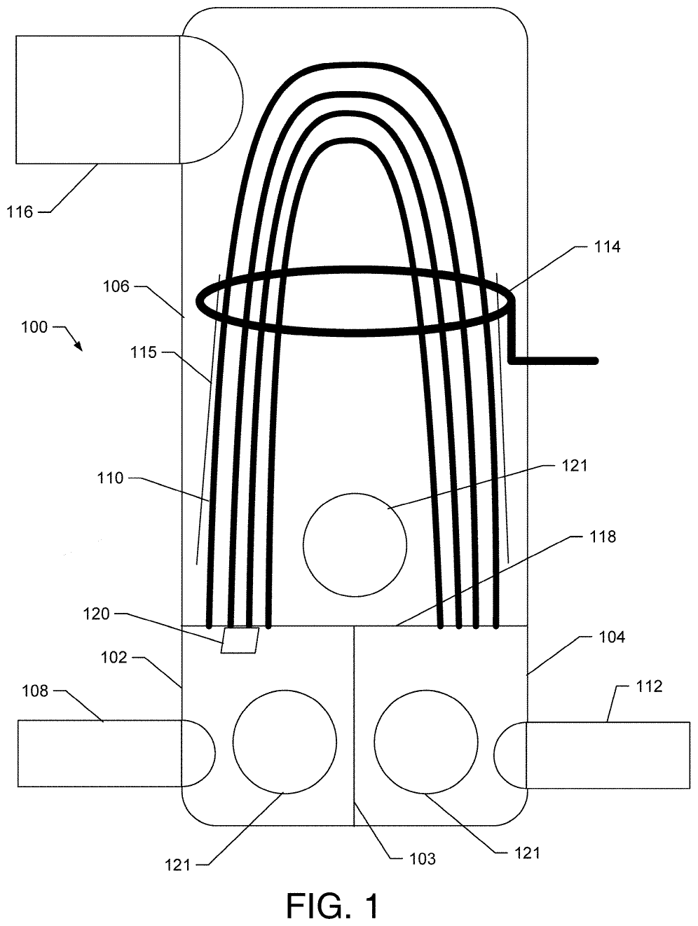

FIG. 1 illustrates an example heat exchanger 100 according to an example embodiment. Heat exchanger 100 may include a heat source side including a hot leg 102 and a cold leg 104 separated by a divider plate 103. Heat exchanger 100 may also include a heat sink side 106 separated from the heat source side by a tube sheet 118. Tube sheet 118 may include a plurality of heat transfer tubes 110 that pass through heat sink side 106.

In operation, heated fluid, such as water, flows into heat exchanger 100 through inlet piping 108 to hot leg 102. The fluid enters tubes 110 through tube sheet 118, transfers heat to fluid flowing through heat sink side 106, discharges into cold leg 104, and exits heat exchanger 100 through outlet piping 112. On heat sink side 106, cooler fluid (relative to the hot water passing through tubes 110), such as water, enters heat exchanger 100 through a feed ring 114 and passes downward over a thermal shroud 115 to tube sheet 118. Thermal shroud 115 separates the feed water from direct contact with the tubes as the water flows downward from feed ring 114, thereby allowing the feed water to be first warmed by heat from the fluid within thermal shroud 115 as the fluid on the outside of thermal shroud 115 passes to tube sheet 118, thereby reducing or preventing thermal shock to tubes 110. The fluid then passes under thermal shroud 115 into a volume defined by the shroud and containing tubes 110 and flows upward, receiving heat energy from tubes 110, thereby generating steam. The steam exits the heat exchanger 100 through a steam pipe 116 to be utilized by steam systems, such as turbine generators.

Heat exchanger 100 may be inspected periodically to monitor for corrosion and/or chemical build up that may degrade the normal operation of heat exchanger 100 and/or result in a leak from the heat source side, e.g. hot leg 102 and cold leg 104, to heat sink side 106. Due to the geometry of tubes 110 and their proximity to each other, tubes 110 and, correspondingly, tube sheet 118 can be susceptible to corrosion and chemical build up. Additionally, due to space constraints and/or other hazards, such as radiation and contamination in nuclear applications, the inspections are typically performed by a robot 120 inserted into heat exchanger 100 through a manway 121. The depicted heat exchanger 100 is a vertical steam generator, which is described merely for illustrative purposes. One of ordinary skill in the art would immediately appreciate from the present disclosure that the systems and methods described herein may be employed on various types of heat exchangers and in various heat exchanger orientations.

### Example Robot

FIGS. 2A and 2B illustrate an example robot 120 according to an example embodiment. Robot 120 may include a body 126, an end effector 122 holding a tool 123, and a camera 124. It should be understood that various robot structures may be utilized in accordance with the present disclosure. One example robot is manufactured by Zetec, Inc. of Snoqualmie, Wash. under the model name ZR-100. Body 126 may house processing circuitry, such as the processing circuitry 50 discussed below in reference to FIG. 14, or the processing circuitry may reside at a computer system remote from the robot housing, or in both places simultaneously. The body may include a mobility system, e.g. in the ZR-100 including one or more electric motors disposed within the robot housing and under the control of processing circuitry 50 (FIG. 14) via relays (not shown) that control the application of power from the robot's battery power source (not shown) to the motors. Respective motors, solenoid devices, or other actuators drive one or more corresponding extendable and retractable pins (not shown) disposed within the robot housing in contact with the tube sheet surface. A first set of four of the pins is disposed in a first part 117 of the robot's housing. A second set of three of the pins is disposed within a second part 119 of the robot housing that is movable with respect to the first housing part. The pins are extendable from and retractable into their respective housing parts. To move on the tube sheet, the robot extends one set of pins into respective tube openings, while retracting the other set. The robot then moves the housing part with the retracted pins with respect to the housing part with the extended pins. The pins' locations with respect to each other on their housing parts are such that the robot can be oriented on the tube sheet such that all pins of the one set or the other can extend into respective tube sheet openings. Further, the robot's control processor, knowing the robot's position and orientation on the tube sheet, controls the stroke distance of the one housing part's movement with respect to the other housing part so that at the end of the stroke, two or more of the retracted pins are over open tube openings. After the stroke, then, the robot control processor extends the retracted pins from their housing part into the tube sheet openings (in some instances, in which only two pins are over open tube sheet features, the processor extends only those two pins), thereby securing the robot's new position. The robot control processor then retracts the original pins from their tube sheet openings into their housing part and moves that housing part up to or past the other housing part (from which the pins are now extended into tube sheet openings) to a new position over a new set of tube openings, and the procedure repeats so that, by such leap-frogging of the two housing parts, the robot moves in its intended direction. Further, the three-pin set is disposed in a section of its housing part 119 that is rotatable about a vertical axis within the housing part. When a change in the robot's direction on the tube sheet is needed, and when the pins of this section are inserted into respective tube openings and the pins of the other housing part are retracted from the tube sheet, the robot processor rotates the rotatable section to thereby change the robot's tube sheet heading. Accordingly, the processing circuitry, in response to instructions received from the operator, moves the robot about the tube sheet 118 by actuation of the one or more pin actuating devices, one or more motors that control relative movement between the housing parts, and a motor that controls the rotatable section. In one or more embodiments, the operator inputs such instructions via a map of the tube sheet tubes that the system presents to the user at a user interface. Through an input device, such as a keyboard, mouse, or touch screen, the user selects on the map a target tube to which to direct the robot. The processor receives the input instruction, and the system programming, knowing the robot's present position on the tube sheet, calculates the direction instructions to provide the robot to move toward the target tube. The creation of such instructions is beyond the scope of the present disclosure and is not discussed in further detail herein.

As should be understood, a motor encoder is an electro-mechanical device driven by the output (e.g. a shaft) of a motor to which it is attached or otherwise is a part that outputs a signal that corresponds to the shaft's angular position and/or continuing rotation. Each of the robot's electric motor(s) that drives the relative position between the two housing parts or rotation of the rotatable section has an encoder that outputs a signal to the processor, which in turn receives and collects the signals. The processor is calibrated to translate the signal from the encoder for the motor that drives relative movement between the housing parts and, therefore, linear movement of the robot housing into a distance traveled by the robot from a known initial position, into distance data from that initial position. The processor is also calibrated to translate the signal from the encoder for the motor that drives the rotatable segment into angular rotation of the robot from an initial orientation. By accumulating such distances and angle changes in sequence, the processing circuitry thereby tracks the robot's movement and positions over the tube sheet surface from a known initial position.

For instance, and continuing with the discussion of the robot's operation based on encoder data, processing circuitry 50 includes a memory storage 54 (FIG. 14) at which is stored data in a truth table, the data of which defines a map of the surface of tube sheet 118 upon which the robot travels. As discussed below, the map includes locations of the tube openings on the tube sheet and includes one or more initial positions on the tube sheet at which the operator can and will place the robot to begin an inspection routine as discussed herein. These positions may, for instance, be identified in the data as coordinates in a two dimensional space corresponding to the tube sheet surface. The data also includes the robot's initial orientation (rotationally, about an axis passing through the robot and normal to the surface of tube sheet 118) on the tube sheet surface. The programming of a processor 52 (FIG. 14) assumes an initial position of the robot's direction wheel(s), such that if the robot is controlled to move, without changing the direction of the robot's initial orientation, the direction on the tube sheet surface in which the robot will move is also known. Via the user interface, the operator provides the processor instructions to move the robot, for example by indicating a target tube through the user interface map to which to direct the robot, as described above, such that the system generates direction control instructions, including whether, and to what degree, to change the robot's direction (corresponding to some degree of rotation of the above-described housing segment about its tube sheet-normal axis). The program then causes the processor to control the robot's pin actuators and direction/movement motor(s) to cause the robot to move in the desired direction(s) on the tube sheet surface. The processor also receives the encoder signals, thereby confirming the direction within the tube sheet space in which the robot is moving from the initial position, in response to which the processor repeatedly updates the robot's position (moving away from the initial position) in a record in memory 54 in the direction confirmed by the rotatable segment encoder signal in increments that correspond to the drive wheel encoder signal as determined by the processor's calibration. This process continues until the processor determines that the robot has reached its position objective or otherwise receives a stop instruction, or an instruction to change robot's direction, from the operator via the user interface, at which point the robot's present tube sheet position becomes the new initial position if the operator changes direction (as indicated by the direction encoder) and again moves the robot on the tube sheet surface. Accordingly, the motor encoders provide an indication of travel distance and travel direction on the tube sheet surface, enabling the processing circuitry to determine a location change and an orientation change from a predetermined start location and interim locations as the robot moves about tube sheet 118, independently of the image-based location methods.

End effector 122 may secure one or more tools 123, such as an eddy current probe, for inspection and/or repair of the tubes 110. Robots for traversing and imaging tube sheets as described herein, having such effectors and cameras, are known, for example manufactured under the model name ZR-100 by Zetec, Inc. of Snoqualmie, Wash.

The construction and operation of such robots with respect to engaging and traversing the tube sheet, being understood in the art, are not discussed in detail herein. Generally, however, and for example in an embodiment in which processing circuitry 50 (FIG. 14) is located in a computer system remote from the robot housing, the processing circuitry communicates with circuitry housed by the robot housing that (a) controls electronics that drive the tool(s) associated with the end effector, (b) controls the electronics which drive the mobility system, and (c) interacts with control circuitry and memory at the camera so that the camera controller transmits acquired image data to processing circuitry 50 via the robot circuitry for data processing at processing circuitry 50 and display at user interface 60 as described herein, either on a real time basis or intermittently after first storing sequential images in the camera system memory. In embodiments in which processing circuitry 50 is located in a remote computer system, functions of the processing circuitry as discussed herein may be shared between the remote processing circuitry and processing circuitry within the robot, which communicate with each other in effecting such functions. In that sense, the processing circuitry discussed herein may be considered to encompass the processing circuitry both in the robot and in the remote system. In some embodiments, the image data is video data transmitted via the robot electronics to processor system 50, which in turn drives a display at a corresponding computer system with the video feed so that a user at the computer system can see the tube sheet surface below camera 124 as the user operates the robot. In some embodiments, additional camera data may also be displayed, for example from a camera associated with end effector 122 and/or a camera directed into the heat exchanger to monitor the placement of the robot 120.

The operator operates the robot via a user interface 60 (FIG. 14) at the remote (physically remote, from the robot) computer system utilizing input devices, such as computer keyboard keys designated by the computer program executed at the remote computer system, a mouse, or other input devices. Via the input devices, the operator inputs instructions to the user interface regarding the desired movement direction of the robot, as discussed above. Upon receiving these instructions from the input device via the user interface, processing circuitry 50 (FIG. 14) transmits the instructions to control circuitry within the robot housing via the hard-wired connection between the robot control system and the processing circuitry, where the control circuitry controls the encoder motors to move the robot in the direction indicated by the operator instructions, as discussed above. As the robot moves, the camera circuitry outputs a video feed to processing circuitry 50, which in turn drives the user interface to display the video feed so that the operator can view the tube sheet as the robot moves over the sheet. The control circuitry also controls the tools associated with the end effector, such as deploying and retrieving an eddy current probe into or from a tube 110.

Camera 124 may be a digital camera having a processor and executable code stored in memory at the camera that is executable by the processor so that the camera is configured to capture image data, including fixed images or moving images. In some example embodiments, camera 124 captures images at a frame rate of 30 Hz (images per second), 60 Hz, or the like. In some example embodiments, camera 124 includes a wide angle lens, such as a fish eye lens, to broaden the camera's field of view and thereby maximize the viewable area of the tube sheet within the image data of a given acquired image, which may increase the number of tube sheet characteristics in each frame of the image data. Camera 124 is mounted on the robot so that the camera's field of view is directed downward, relative to robot 120, to capture image data that encompasses a portion of tube sheet 118. In some example embodiments, robot 120 may include or be associated with one or more tools, which may be disposed at and gripped by a distal end of the end effector or elsewhere on robot 120. Each tool may be disposed a predetermined and known distance from camera 124.

In certain embodiments, the end effector includes a rotatable unit at the end of the end effector's boom, with the tool being disposed on the rotatable unit. A motor is disposed at the boom end, under the control of the robot processor, to rotationally drive the rotatable unit in response to control signals issued by the robot's mobility control processor. The motor may include an encoder disposed on the motor so that the encoder outputs a signal to the system processing circuitry that corresponds to the rotatable unit's, and therefore the tool's, rotational position (with respect to a predetermined rotational position) about a vertical axis passing through the rotational unit's rotatable attachment to the boom end. Since the rotational unit's length from the boom end, and therefore the tool's distance from the boom end, is known and stored in memory accessible by the processor, and the encoder's data indicates the rotational unit's angular position at the boom end with respect to a predetermined orientation, the system processing circuitry knows (a) the horizontal distance from the camera's vertical field of view axis to the vertical axis of rotation between the rotatable unit and the boom end (stored in system memory), (b) the horizontal distance between the vertical axis of rotation between the rotatable unit and the boom end and a vertical axis passing through the tool, and (c) the angle (in the horizontal plane) between those two distance vectors. Thus, for any given angular position of the rotatable unit with respect to the boom end, this data defines two sides of a triangle (the two distances) and the angle therebetween. Accordingly, for each such angular position, the system processing circuitry determines the third side to the triangle through side-angle-side triangulation, thus identifying the horizontal distance between the camera's vertical field of view axis and the vertical axis passing through the tool and the angular offset (in the horizontal plane) between the distance vector from the camera's vertical field of view axis and the vertical rotational axis between the boom end and the rotatable unit and the distance vector from the camera's vertical field of view axis and the vertical axis passing through the tool. It will be understood, in view of the present disclosure, that the latter distance vector is the relevant vector for use in the heat exchanger inspection method described below. For ease of explanation, this description assumes that the system has rotationally positioned the rotatable unit so that the horizontal distance vector between the vertical axis of rotation between the rotatable unit and the boom end and the vertical axis through the tool is aligned with the distance vector between the camera's vertical field of view axis and the vertical axis of rotation between the rotatable unit and the boom end, such that the horizontal distance from the camera's vertical field of view axis and the vertical axis through the tool is the sum of these two distances and that the angle between a vector from the camera's vertical field of view axis to the vertical axis through the tool and a vector from the camera's vertical field of view axis to the vertical axis of rotation between the rotatable unit and the boom end is zero. It should be understood in view of the present disclosure, however, that the system may control the rotatable unit to be positioned at various angular positions and, in such event, the system processing circuitry will determine the distance vector from the camera's vertical field of view axis to the vertical axis through the tool based on encoder data as described above and adjust the vector's angular orientation accordingly.

### Example Heat Exchanger Inspection

Robot 120 may be utilized with its associated camera 124 and end effector 122/tool 123 to perform an inspection of heat exchanger 100 (FIG. 1), including automatic inspection by and guidance of the robot, by tracking the robot's location through the heat exchanger based on image data acquired by the camera as the robot moves rather than upon aggregation of sequential robot movements. The inspection method tracks the robot's location based on the image data to determine the location of end effector 122 and its tool 123 to verify that the processing circuitry associates the data received from the tool with the correct tube 110. Image-based location tracking may be either the primary or sole, independent determination of the location of the end effector 122. Alternatively, it may be used in association with other tracking methods, e.g. to verify the end effector position that is otherwise determined based on the position change indications from the one or more motor encoders, as discussed above, or as a primary position determination method that is verified by the encoder tracking method. In an example embodiment, robot 120 may be placed in the heat exchanger, for example, at a predetermined point on tube sheet 118. This is accomplished by an operator passing the robot through manway 121, which is positioned with respect to tube sheet 118 so that the operator can physically place robot 120 on sheet 118 so that the camera's field of view is disposed downward, toward the tube sheet. The camera is secured to the robot housing so that when the robot is mounted on the tube sheet by the mobility system, the central axis of the camera's field of view, which may be considered the camera lens optical axis, is vertical and perpendicular to the generally planar horizontal surface of tube sheet 118. The robot's initial position on the tube sheet is predetermined and may be, for example, indicated on the tube sheet by markings so that the operator can detect the correct position visually when placing the robot 120 on the tube sheet through manway 121 or via visual review of image data at the computer system display when the camera acquires image data after its placement on the tube sheet. The operator places the robot on the tube sheet surface in a predetermined orientation, which may be considered the robot's rotational position about the robot camera's vertical optical axis, by placing the robot housing pins (described above) of one of the two housing parts (e.g. housing part 117, FIG. 2B) in predetermined respective tube openings in the sheet.

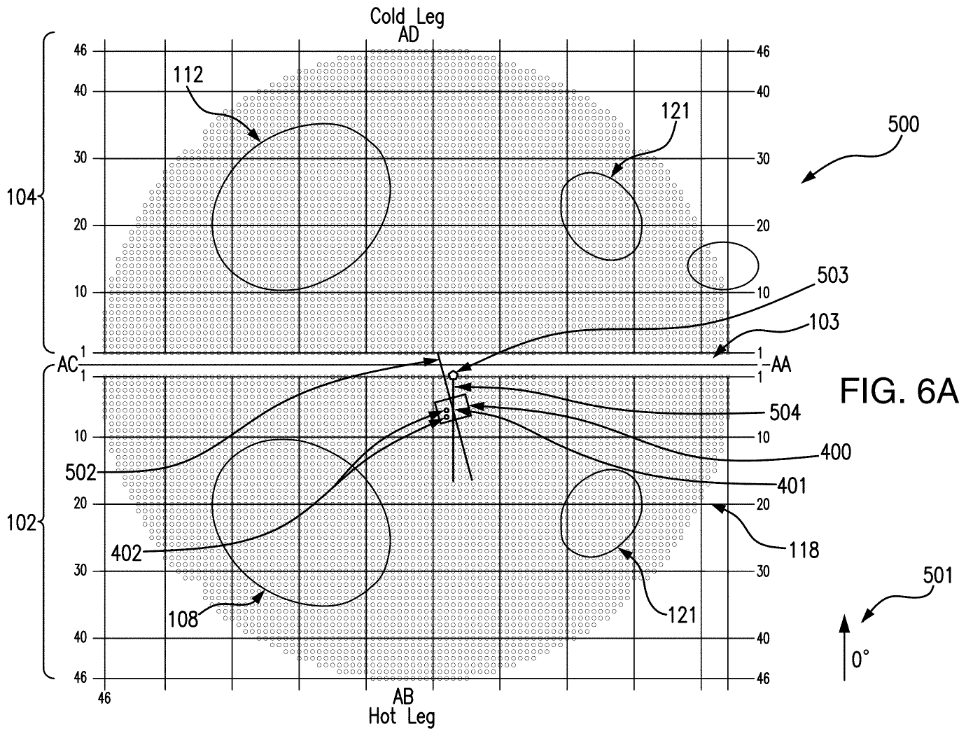

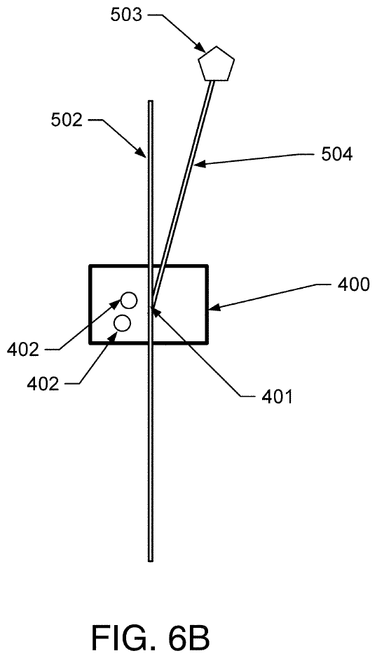

The present discussion refers to a tube sheet space. Tube sheet space is a two-dimensional coordinate system that can be considered to overlay a tube sheet surface, such as depicted at FIG. 6A, at which are located the tube openings and other features, such as plug tubes, stay tubes, indicia identifying one or more open tube positions (i.e. positions at which the sheet surface is smooth and uninterrupted), sheet edges, etc., that will also be identifiable in the camera's image data. The position of each feature on the tube sheet surface can be described by coordinates of the two-dimensional coordinate system. In the example discussed herein, the tube ends connect with tube sheet 118 in a grid as shown at FIG. 6A, so that two orthogonal axes may be defined such that all the tube openings, plugs, stays, etc. align in rows and orthogonal columns. The coordinate system may be defined, therefore, in terms of a first axis parallel with the tube opening rows and a second axis parallel with the tube opening columns. The coordinates correspond to actual distance in tube sheet space (e.g. in inches) on each axis from an origin point at the intersection of the two coordinate axes, e.g. at one corner of the tube sheet surface immediately outside an outer perimeter of the collection of tube openings. The coordinates for each tube identify the locations of the center of the respective tube sheet opening on each of the two axes. Accordingly, the truth table associates each tube (individually identified in the truth table data by its row and column numbers as reflected by FIG. 6A) with the actual location of the center of the tube opening (defined in terms of the coordinate system's dual-axis coordinates) for that tube, where the dual axis coordinates are defined by tube sheet space distances along two perpendicular axes from a predetermined origin point on the tube sheet in tube sheet space. By so locating each tube sheet opening in tube sheet space, the truth table identifies the distance between each tube opening and each other tube opening or other feature in tube sheet space and the orientation of each tube opening with respect to each other tube opening in tube sheet space. Thus, the tube sheet space is a two-dimensional space defined by a reference system (e.g. a coordinate system) in which the locations of predetermined features are identified. The manner in which features are identified can vary. For example, in presently described embodiments, the ideal diameter of each of the tube openings (i.e. the diameter created by the drilled hole, before the corresponding tube is welded to the sheet at the hole, modifying the visible diameter by the weld rollover) is known, and it is therefore sufficient to identify the position of a tube opening in the tube sheet space by identifying the coordinates of the (ideal) center of each tube opening, plug tube, or other circular characteristic. In addition, and as noted above and also discussed below, the tube sheet features may be aligned with each other in a grid-like fashion, so that each feature can be defined by a row and column of such features. In such a system, each tube opening's (or other feature's) ideal center, along with the tube's tube mark (if a tube mark exists), may be associated in the table with the corresponding tube's row/column number and with the (ideal) center point's distance coordinates in the two-dimensional reference system. This data, in this example the truth table, is stored in memory associated with processing circuitry 50. As noted, the table includes an entry for each tube sheet opening or other feature, with each entry including an identifier for the feature (e.g., a tube mark and/or a row/column identifier) and the coordinates for each feature's position (e.g. the ideal center of a tube opening or other circular feature) in the two dimensional tube sheet space coordinate system. In certain embodiments, the truth table includes, in addition to each tube opening's ideal center point, each tube's inner and outer diameter values defined by the tube opening's actual or expected weld rollover. As should be understood, the weld rollover defines inner and outer diameters visible for the tube opening on the tube sheet and, therefore, in the images discussed herein.

Processing circuitry 50 (FIG. 14) translates data detected in images acquired by the robot camera into tube sheet space, so that positions of tubes that are within each acquired image are identifiable in tube sheet space and stored in memory. This, in turn, enables the processor to determine data identifying the tube sheet map coordinates of such tubes and an orientation of the robot. Although, in the present embodiment, the processor does not store the image, in other embodiments, the processing circuitry stores each image in memory 54 (FIG. 14) in association with data identifying the pixel position in the image of each tube sheet feature in association with the tube sheet truth table coordinates and/or row/column identifier for each such feature. In such embodiments, the image is also stored in association with a time stamp for the time at which it was acquired. Accordingly, if desired, the accumulated stored images can be sequenced to provide an image record of the robot's activities.

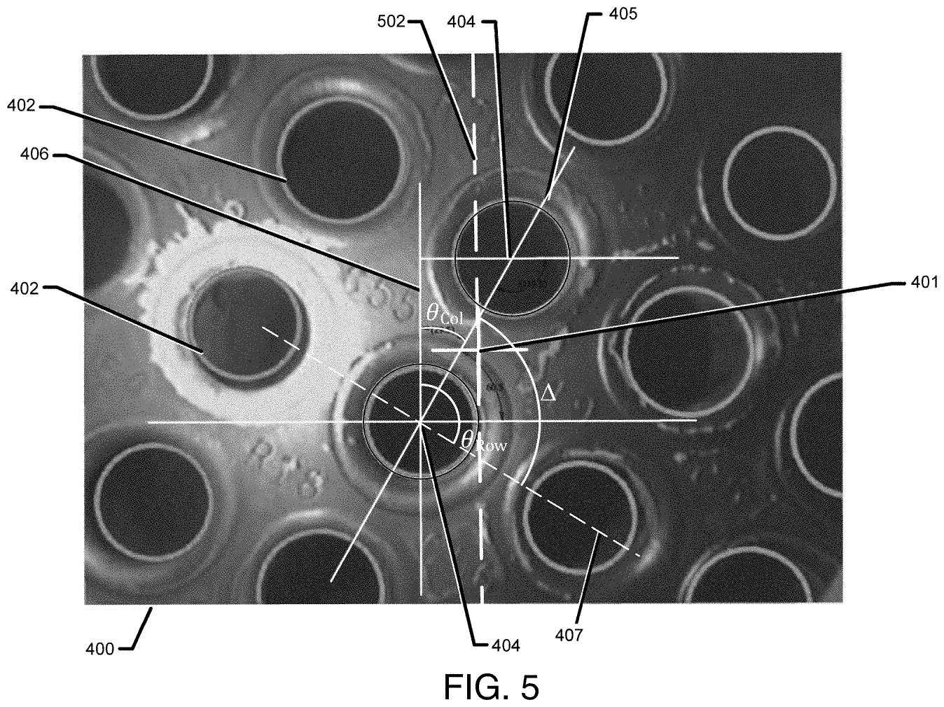

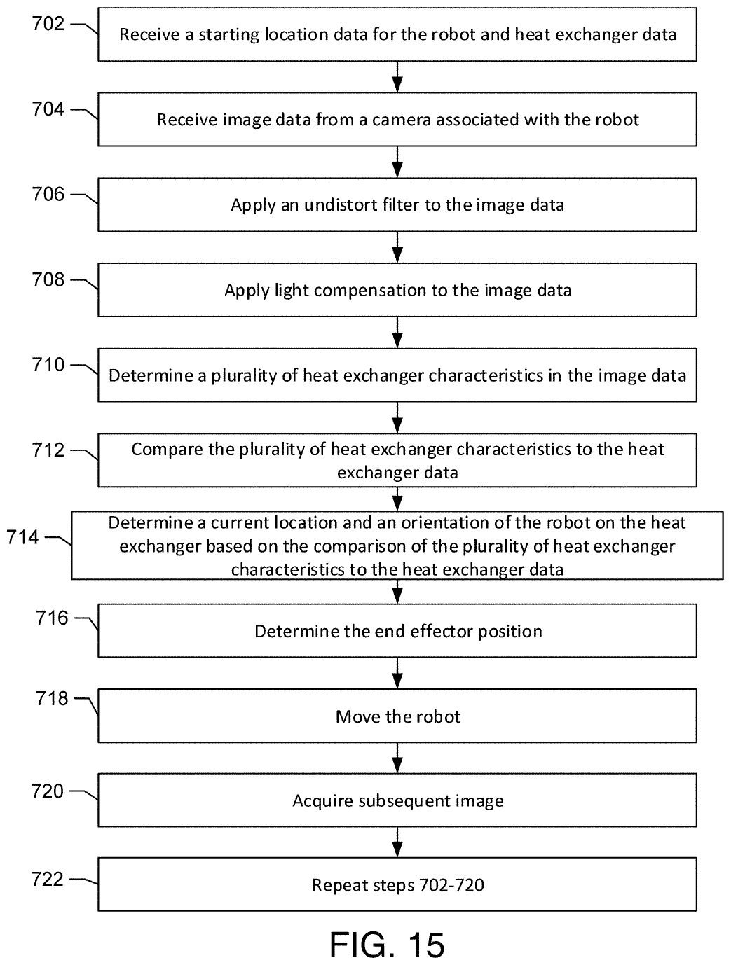

The discussion below, with reference to the steps provided at FIG. 15, the image provided at FIG. 5, and the user interface display illustrations of FIGS. 6A and 6B, provides an example of a method for tracking a robot on a surface such as a tube sheet of a nuclear reactor. At 702, the operator or system processing circuitry receives information identifying the robot's start position on tube sheet 118. In the embodiments described herein, this may comprise the identity and location, in tube sheet space, of at least two tube sheet characteristics that are expected to appear in an initial image acquired by the robot camera when the robot is at its initial position on the tube sheet. Where the tube sheet characteristics are tube openings, the identification information may include markers that may be provided at each of these tubes, e.g. row/column identifiers, or other identifying marks, as described below. The processing circuitry also receives the truth table, which correlates the row/column identifier for each tube opening, plug tube, tube stay, etc. with the center position for such tube sheet characteristic in terms of the two-dimensional coordinates in tube sheet space, and data sufficient to present the underlying tube sheet map such as illustrated in FIG. 6A, as described above. The processing circuitry stores this data at 54 (FIG. 14) for use by the processing circuitry's programmed processor, as discussed herein.

In one or more embodiments, the tube sheet position at which the operator initially places the robot is not necessarily the initial position at which the tracking operation begins. For example, as described above, the tube sheet may be marked so that the operator, positioned at the manway, may locate the robot in the operational starting position such that two or more of the four pins of housing part 117 (FIG. 2B) are inserted into the respective predetermined tube openings for those pins, thus locating the robot in its predetermined starting location and orientation on the tube sheet. This position may be referred to herein as the robot's operational initial position. As described herein, the camera is directed downward toward the tube sheet surface when the robot is in this position, so that the operator can view the tube sheet surface from the camera feed at user interface 60 (FIG. 14). The robot carries another camera (not shown) directed from the camera housing to the end effector and tool, at an angle so that the camera's field of view also encompasses the tube sheet surface and tube opening at which the tool is inserted. When the operator places the robot at the operational initial position and then returns to the control computer/user interface 60, the operator actuates the robot by conveying a control instruction to the processing circuitry via the user interface and controls the computer's input device to identify the robot's operational initial position and to select a predetermined position on the tube sheet surface, e.g. a tube opening on the tube sheet at which, when the robot is positioned there, the end effector camera should be able to view a unique tube sheet surface feature, for example a marking or sheet edge corner having a shape that occurs only once over the sheet or over a known portion of the sheet. As the user has identified to the processing circuitry the starting and ending points for the robot's travel, the processing circuitry determines the robot movements needed to traverse the tube sheet from the starting position to the ending positions and controls the robot to make such movements. Once the robot executes the movement, the operator views the feed from the end effector camera at the user interface. If the robot was properly placed on the tube sheet correctly at the operational initial position, the operator should see the expected tube sheet feature from the end effector camera feed. If the operator does see that feature, the operator knows that the robot has been correctly placed in the correct location and orientation on the sheet at the operational initial position. The operator then selects, at the user interface, a tube sheet position corresponding to the robot's tracking initial position, at which at least two predetermined tube openings or other features will be visible in the image feed from the robot's main camera. Now confident of the robot's location and orientation, the operator selects this tracking initial position, so that the processing circuitry determines the robot movements needed to move the robot from its present position to the initial tracking position and controls the robot to execute that movement.

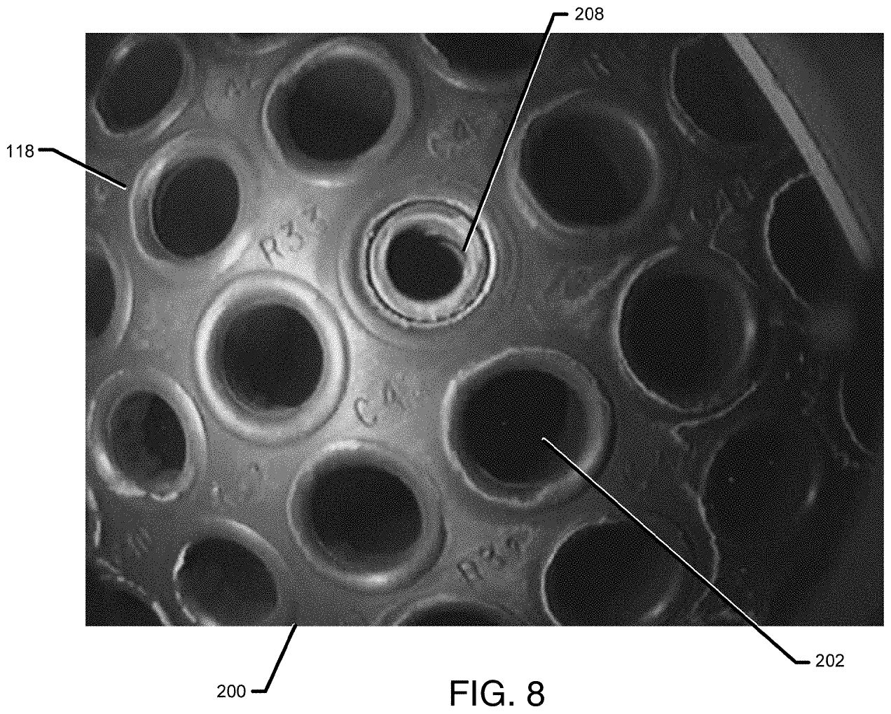

Once the robot reaches the predetermined initial tracking position on the tube sheet so that the main robot camera's field of view faces downward toward the tube sheet surface and encompasses the at least two predetermined tube sheet features, for example tube penetrations, plug tubes, stay tubes, or the like, the robot camera acquires an initial image. The camera outputs the image data to the system processor, which receives the image data at 704. As discussed in more detail below, where the camera includes a wide angle lens, the processing circuitry may apply an undistort filter at 706 and may apply light compensation to the acquired image data at 708. At 710, the processor assesses the image data to identify any circular feature that meets certain predetermined criteria for defining a normal tube opening (see FIG. 3) or a plug tube opening (see FIG. 8). Such criteria are defined within the software stored at 54 (FIG. 14).

To detect the heat exchanger characteristics at 710, processing circuitry 50 (FIG. 14) may be configured through its programming to analyze each frame of image data 200 (FIGS. 3A-4B), e.g. such as after lighting compensations, and/or image flattening, to determine, e.g. detect, one or more heat exchanger characteristics, such as tube locations 202, in the frame. In an example embodiment, processing circuitry 50 may, additionally or alternatively, apply a gray scale and/or a Gaussian blur filter to each frame to clarify the frame at a pixel level. As should be understood, a Gaussian blur filter de-warps the image, compensating for spot lighting and taking sharp edges off corners. Such filters should be understood and are, therefore, not discussed further herein. Processing circuitry 50 repeatedly analyzes through each frame, pixel by pixel, a predetermined number of times, such as one time, five times, ten times, or the like, to detect heat exchanger characteristics. For example, processing circuitry 50 may apply a Hough circle transformation to detect circular heat exchanger characteristics, such as tube locations 202 (FIGS. 3A, 3B, 8) in tube sheet 118. In an example embodiment, processing circuitry 50 may compare detected circles to one or more predetermined heat exchanger characteristic thresholds. For example, processing circuitry 50 may include a size threshold range and/or a center gap threshold range for a determination of a tube location 202. For example, having detected a circle in the image space, the processor determines the diameter of that circle in image space. The processor may determine the diameter by calculating the number of pixels in image space spanning the diameter. Because the robot, and therefore the robot's camera, is always disposed in the same position and orientation with respect to the tube sheet surface when it acquires a camera image, there is a predetermined correspondence between pixel distance in image space and inches in the two-dimensional coordinate system in tube sheet space. This correspondence is determined by calibration and programmed in the processor circuitry's computer instructions. Thus, having measured a distance in image space in pixels, e.g. the diameter of a detected circle, the processing circuitry is able to convert that image space pixel distance to a tube sheet space distance and compare the tube sheet space distance to a predetermined distance criteria for the applicable parameter. If the detected-circle diameter falls within the predetermined range (which may be determined through calibration, e.g. considering weld rollover, or otherwise selected by the user, and entered to the processing circuitry's parameter data by the user through the user interface), the processing circuitry determines that the circle represents a tube opening, plug tube, or the like. If the circle is outside the range, the processing circuitry determines the feature is not a tube opening or other tube-related feature. The range may be defined in memory as a threshold value, +/−a variability factor, or as a threshold + an upper variability factor and − a lower variability factor. Having detected all qualifying circles in the image, the processing circuitry identifies the respective centers of all of the so-identified circles in the image.

Thus, the processor, at this point, knows the pixel position in the initial image of each of a predetermined type of tube sheet characteristic. At 712, the processor compares this information to known data that describes the heat exchanger surface to thereby, at 714, locate the acquired image, and therefore the robot's position and orientation, on the heat exchanger (in this instance, the tube sheet) surface.

The comparison of the image data with the tube sheet data for the initial tracking image is based on the operator's identification of at least two predetermined tube sheet characteristics in the image. The processor drives user interface 60 (FIG. 14) to display the image for the operator's view. As discussed above, at least two of the characteristics, e.g. at least two of the tube openings or plug tubes, are marked in such a way that they are individually and distinctly recognizable to the operator in the display image. For example, as illustrated in FIGS. 3A and 3B, the two or more tube openings and/or plug tubes may have a corresponding mark 204 stamped on the tube sheet surface at a predetermined position proximate the opening. Each mark is associated in the truth table with the row and column numbers of its corresponding tube location in an array of tube locations defined by tube sheet 118 (and, optionally, with the x/y locations in the Cartesian coordinate system of the centers of the characteristics in tube sheet space). The locations of these features are predetermined and recorded in the truth table that describes the surface of the tube sheet 118, and as represented by a tube sheet map 600 discussed herein with respect to FIG. 6A. Each mark is, therefore, unique to its tube sheet opening with respect to any marks for any other tube sheet openings that may be present on this tube sheet. Tube markers 204 may be obscured by chemical build up or degradation, or may otherwise not be detected in the image data, which may render one or more of the tube sheet markers ineffective for location determination, and in certain embodiments more than two markers, or other forms of markers, may be provided, such as painting or notching or providing raised areas about a tube opening in such a way as to be distinguishable from all other tube openings, as illustrated in FIG. 5, to be an indicator that the so-marked tube opening is one of, or is adjacent to one of, the two or more intended tube sheet characteristics. In such alternatives, confidence may be increased that sufficient markers will be available to identify the robot's initial position in tube sheet space.

When the processor displays the image at user interface 60 (FIG. 14), the processor also displays two (or more) of these marks, corresponding to the two (or more) predetermined tube openings or other characteristics that should be visible in the image if the robot is at the proper initial tracking position (this should be true where the operator has confirmed the robot's initial operating position as described above), with an instruction to identify the location of those characteristics in the interactive display. Stored in memory is the row/column (in tube sheet space) identifications for each predetermined characteristic, so that the processor knows the row and column location on the tube sheet surface grid of each such predetermined characteristic. If the operator visually locates in the image the two (or more) tube sheet characteristics that correspond to the designated markings, the operator utilizes the user interface's input system (e.g. a touch screen, keys of a keyboard, or a mouse) to indicate within the interactive display at the user interface the location (e.g. by locating the approximate center of the circle of the characteristic) of the tube openings or other features in the image that correspond to those designated marks. For example, the operator may use the user interface input system to first select one of the two (or more) predetermined characteristic icons presented on the screen (to thereby notify the user interface programming which of the two features the operator is about to identify in the interactive display), then select the position on the user interface display at which the selected characteristic appears (e.g. its center) in the presented image, and then repeat the process for the other of the two (or more) presented characteristics. This causes the user interface to output a signal to the processing circuitry that identifies the positions on the user interface screen (i.e. the pixel position in image space) selected by the operator, along with an identification (e.g. column and row identifiers or simply an identifier of the user-selected mark that the processor can associate with the correct column/row identifier, or x/y Cartesian location, of the applicable predetermined characteristic based on association of the identifier with that information in the system database) of the predetermined tube sheet characteristic corresponding to each selection. The processor, executing the program as discussed herein, knows the correspondence between the image at the user interface display and the pixel locations in the acquired image data. Thus, the operator's selection at the user interface locates the image pixel positions for those two (or more) selections. The processor then determines whether each selected pixel location is within a predetermined tolerance of any tube sheet center located in the initial image analysis described above. If, for either selection, the selection does not so correspond to any of the located tube feature centers, the system processor sends a signal back to the user interface processor, the programming of which causes the user interface processor to display an error message at the user interface display and await an alternate selection by the operator. If the pixel selection is located sufficiently close to one (but no more than one) of the tube sheet feature centers identified as described above, the system processor correlates the corresponding predetermined characteristic identification (e.g. the corresponding tube mark and/or row/column identifier) from the operator's selection with the center of the tube opening (in terms of image pixel location) in image space. This process repeats until the system processor correlates each of the operator's selections at the user interface with a corresponding tube sheet characteristic that has been identified within the image.

At this point, the processor knows the locations of the two characteristics within the image space, as defined by their pixel locations. The processor also knows the pixel locations of all other tube characteristics identified in the image, as described above. The processor then identifies the relative positions of the two identified predetermined tube sheet characteristics with respect to each other and the other tube centers identified in the image, e.g. whether the selected and identified predetermined tube sheet characteristics are adjacent each other in the image, with respect to the other tube sheet characteristics identified in the image, or if there are other tube sheet characteristics in the image disposed between the two identified predetermined tube sheet characteristics and, if so, how many.

As discussed above, the system program may be calibrated so that the processor can translate distances in image space into distances in tube sheet space. For example, prior to locating the robot onto the tube sheet, the operator may place the robot onto a surface upon which are marked at least two surface characteristics, the size of, or distance between which, is known. The surface is at the same position with respect to the camera as will be the tube sheet surface when the robot is placed on the tube sheet. The robot camera acquires an image of the calibration surface and outputs the image to a calibration system that displays the image on an operator screen. An operator locates the two characteristics on the screen using an input device such as a mouse or a keyboard, in a manner similar to that discussed above with regard to location of the predetermined tube sheet characteristics, and the calibration program determines the pixel location of the two characteristics in the image. The operator enters the actual surface distance between the two image characteristics or a dimension of the characteristic (e.g. the diameter of a tube opening). Since the calibration system knows the distance between the two characteristics, or the size/diameter of the characteristic, in terms of image pixels, this establishes a correlation between distances in image space and distances in tube sheet space. That is, for example, since the system can determine the diameter of the circular tube openings, and therefore the pixel distance across the opening, this establishes a correlation between the tube opening diameter in image space and distances in tube sheet space. The operator interacts with the program at the system processor to enter this correlation, which the system processor stores in system memory.

Returning to the first tube sheet image, the system processor, executing the program, determines the distance, in pixels, between the center of the first predetermined tube sheet characteristic and the center of the second predetermined tube sheet characteristic. Because the system processor knows the correlation between image pixel distance and tube sheet space distance, the processor applies the ratio of tube sheet space distance/image pixel distance to the determined pixel distance between the first and second predetermined tube sheet characteristics, thereby determining the tube sheet distance that corresponds to the image distance between the first and second predetermined tube sheet characteristics.

Knowing the relative disposition of the two predetermined tube sheet characteristics in image space, and the tube sheet space distance between those characteristics' image positions, the program queries the truth table for all tube numbers (e.g. row/column indicator) corresponding to this tube sheet. The program selects the two tube numbers corresponding to the two identified predetermined tube sheet characteristics and, thereby, the two tube sheet space locations (in this example, in terms of the two-dimensional distance coordinates) for those centers of those tube sheet characteristics. The program determines the tube sheet space distance between those two characteristics, compares that distance with the tube sheet space distance between those two characteristics' image positions, and determines whether the two distances are within a predetermined error threshold. If so, the program determines whether the truth table data reflects the same relative tube sheet orientation between the two predetermined tube sheet characteristics in tube sheet space as the image indicates in image space. For example, if the truth table indicates that the two tube sheet characteristics are adjacent to each other, without any intervening tube sheet characteristics, is that also true of the two identified tube sheet characteristics in image space? If the truth table indicates that the two tube sheet characteristics are separated in tube sheet space by a third tube sheet characteristic whose center is linearly aligned with the two tube sheet characteristic centers, is that also true of the two identified tube sheet characteristics in image space?

If the distance check and the orientation check return positively, the processor has determined that the operator-selected tube sheet characteristics in image space can correspond to the two selected tube sheet characteristics in tube sheet space. If either confirmation check returns negatively, the program determines that the likelihood that the operator-selected tube sheet characteristics in image space can correspond to the two selected tube characteristics in tube sheet space is low. If the check is negative, the processor provides the operator with an instruction at the user interface display that the identification of the two predetermined characteristics has failed and to re-enter the data and then ceases progress of the data analysis until receiving data that matches the criteria. If, however, the check is positive, the processor provides a success notification to the operator at the user interface and moves to the next step.

Because the processor now knows the image space positions of at least two tube sheet characteristics, for which the processor also knows (from the truth table) the tube sheet space locations, the processor can find the tube sheet positions of the other tube sheet characteristics present in the image. To do this, the processor locates each tube opening identified in the image with respect to the two predetermined tube sheet tube openings and then identifies the closest tube opening having the same relationship to those two tube openings in tube sheet space. Based on the image space information, the processor determines each of a plurality of triangles in image space, where each triangle's corners are the pixel locations of the two identified predetermined tube sheet characteristic centers and the pixel position of a respective one of the remaining tube opening centers. Based on the pixel position for each of the three triangle corners in the image (assuming a two dimensional coordinate system in image space in which the position of each pixel is defined), the processor determines the distance in image space between each pair of corners in the triangle. To the resulting known side-side-side triangle, the processor applies the Law of Sines and/or the Law of Cosines at each corner of the triangle defined by the two identified predetermined tube sheet tube characteristic centers to thereby solve for the triangle's angles at those two corners. Of course, these angles should remain the same for the corresponding triangle in tube sheet space. Thus, the processor determines a line in tube sheet space connecting the two predetermined tube sheet characteristic centers and defines a respective line extending from each of the two tube sheet characteristic centers as defined by its corner angle in the corresponding image space triangle. Projection of these two lines in tube sheet space from the two predetermined tube sheet characteristic centers defines, at the lines' intersection, where the center of the tube opening corresponding to third corner in the image space triangle should be. The processor then finds, in tube sheet space, the tube opening center closest to this expected point. If the so-identified tube sheet space tube opening center is within a predetermined threshold distance (defined in tube sheet space) from the expected point, and if there is only one tube sheet space tube opening center within that threshold, the processor considers the so-identified tube opening center in tube sheet space as corresponding to the tube opening center from image space that comprised the third point in the triangle. The processor then acquires the row/column number of the corresponding tube from the truth table, based upon the tube's center location in tube sheet space. If more than one tube opening center in tube sheet space, or if none, is found to fall within the predetermined threshold, the processor does not associate any of the tube sheet-space tube centers with the tube opening center from image space that corresponds to the third point in the triangle. The processor repeats this analysis for every other tube center in the image until all image tube centers are correlated with a tube sheet space tube center or there is a failure to do so. The processor creates a table entry in memory 54 (FIG. 14) that identifies the pixel location of the center of each tube sheet opening or other characteristic identified in the image, and the tube row/column number from the truth table for that tube opening.

The analysis above correlates the tube features in the image with the tube features in the tube sheet map and truth table. The processor also knows the robot's location in the image and can, therefore, identify the robot's location on the tube sheet. Referring to FIG. 5, e.g., the processor identifies the robot's location in image space as the center image pixel at which robot camera optical axis 401 engages the image (considered in terms of the two-dimensional pixel coordinate system). As discussed above, the processor also knows the centers of the two predetermined tube sheet characteristics, which, for purposes of this discussion, can be assumed to be circle centers 404 of the two tube openings to the above-right and below-left of the image center pixel at 401. Thus, the processor defines a triangle in image space with corners at the two centers 404 and the center image pixel at 401. Similar to the discussion above, the processor determines the side lengths of this triangle and, from that information, the triangle's included angles. Also as discussed above, the processor knows the identity of the two tube opening centers 404, of the two predetermined tube sheet characteristics, in tube sheet space. Thus, in tube sheet space, the processor extends lines from the centers of the predetermined tube characteristic centers, at the angles of the corresponding corners of the image space triangle, and identifies the intersection of those lines in tube sheet space, thereby identifying the location in tube sheet space of the position on the tube sheet corresponding to the point at 401 on the tube sheet in image space. This thereby identifies the robot's location in tube sheet space.

Thus, through the comparison of image data to the tube sheet data at 712, the processor thereby identifies at 714 the image's, and therefore the robot's, location in tube sheet space. To determine the robot's orientation about axis 401, also at 714, the processor relies on information relating that orientation to the image. Robot orientation may be important, for example in some embodiments, in order to provide the operator an indication of the robot's heading, so that the operator may more accurately control (remotely, through the user interface and the processor) the robot's movements, and/or to identify the location of the end effector and the tool it carries so that the operator may deploy the tool into a tube in the tube sheet with confidence in the tube's identity. The operator, or the robot's manufacturer, may determine the end effector's position with respect to the camera's optical axis 401 in image space prior to the robot's deployment on the tube sheet and store this information at memory 54 (FIG. 14) for use by the processor's programming as discussed herein. With reference to FIGS. 5, 6A, and 6B, for instance, assume that the end effector is disposed a predetermined distance above robot optical axis 401 beyond the upper boundary of image 400 and along an offset ray 504, where ray 504 is offset from a reference line 502 by a known angle about robot axis 401 in the clockwise direction. The processor identifies the location of line 502 in image space as the center line of pixels in the image, extending between the image's top and bottom. As described above, the location of robot optical axis 401 is also known in tube sheet space. The processor similarly identifies the horizontal image line passing through axis 401, though not shown in FIG. 6A. Because ray 504 passes through axis 401 and is rotationally offset in the clockwise direction by the known angle, the processor also knows and displays the position of ray 504 in the tube sheet space image, as shown in FIG. 6A. Since the processor knows the image space distance (in terms of the discussion herein, the horizontal distance) between axis 401 and the end effector at the end of ray 504, and since the processor knows the distance conversion between actual distance and distance in the tube sheet display as described above, the processor identifies at 716 an icon 503 in the image of the tube sheet at FIG. 6A, at the end of ray 504. With respect to FIG. 6A, this locates the end effector in tube sheet space. By controlling the robot's movements through utilization of the user interface, and the receipt and analysis of subsequent images along the way, as discussed below, the operator can visually detect the end effector's movement over the tube sheet surface. Upon aligning the end effector in tube sheet space over the opening of a tube sheet, as depicted in FIG. 6A, the operator locates the end effector's tool with the desired tube opening and can operate the robot via user interface 60 to control the end effector to insert or remove the tool into or from the tube sheet tube opening. The operator can select the end effector camera feed at the user interface during this process so that the operator can visually confirm the tool's proper insertion into a tube.

This general knowledge of the robot's orientation, however, can include error, e.g. due to distortion in the image caused by a variety of sources, including environmental effects and use of a wide angle lens. Thus, also at 716, the processing circuitry corrects for this error based on a determination of such distortion. The processing circuitry identifies in the image a first line defined by two or more tube sheet characteristics, e.g. tube opening centers, an intersecting second line defined by two or more tube sheet characteristics (i.e. at least three total tube sheet characteristics), and the angle in image space between those two lines. The processing circuitry identifies the same corresponding tube sheet characteristics in tube sheet space based on the truth table and determines the corresponding tube sheet space angle between the intersecting lines they define in tube sheet space. In the absence of image distortion, the two angles should be equal. Thus, the processing circuitry compares the angles, determines any difference between them, and adjusts the robot's previously-determined tube sheet space orientation based on the determined angle error. As described below, each of the two lines defining the angle can be determined based on more than two tube sheet characteristics. The more tube sheet characteristics upon which the error correction algorithm relies, the more precise the alignment of the image to the tube sheet space, resulting in a more accurate orientation angle of the robot. Thus, the use of a wide angle lens at the camera for acquiring the images, as discussed herein, may enable the processing circuitry to include more heat exchanger characteristics in each frame of image data than previous image based location processes, and thereby increase the number of points for reducing error in the orientation angle.

Having correlated the robot's position and orientation in the image to the robot's position and orientation on the tube sheet surface, and determined error arising from image distortion, the processor adjusts the location of the end effector and, thereby, the tool it carries, in the tube sheet representation at FIG. 6A. As discussed above, the processor, knowing the image's location in tube sheet space, illustrates the image's position on the tube sheet representation at FIG. 6A and, knowing the end effector's and the tool's position with respect to the image, also illustrates on the tube sheet representation ray 504 extending from the camera optical axis 401 out to the position 503 at which the end effector and tool are disposed at the tube sheet surface. If the tool is then disposed over a tube opening into which the operator desires to insert and operate the tool, the operator enters control instructions to the processor, via the user interface, for the robot to move the robot arm so that the tool moves into the tube opening. In response, the processor issues a control signal to an electric solenoid device, motor, or other motive control device in operative communication with the robot arm to move the arm so that the tool deploys into the tube opening. The tool now being inserted into the tube opening, the operator issues an instruction to the processor, via the user interface, to actuate the tool. In response, the tool provides a signal back to the processor indicating the result of the test or other operation, and the processor stores the resulting data at 54 (FIG. 14) association with the tube row/column identifier (discussed above) corresponding to the tube under test.

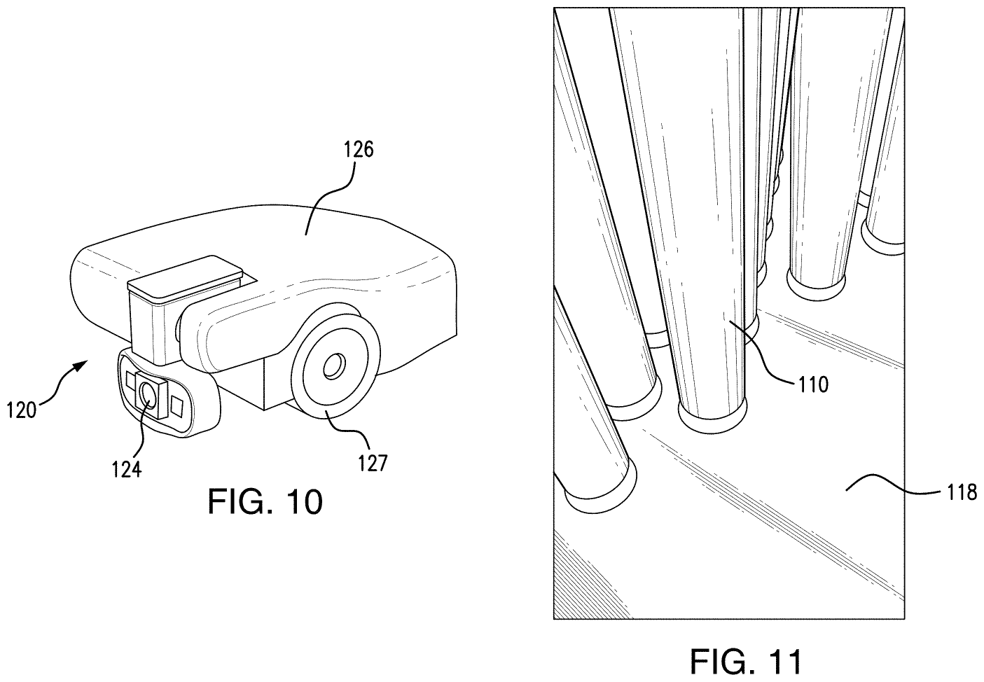

Once the tool operation is complete, or if the tool is not disposed over a tube opening for which use of the tool is desired, then at 718 the operator issues an instruction to the processor, via the user interface, to move the robot on the tube sheet surface in a direction desired by the operator's review of the tube sheet image at the user interface display, as discussed above, or the processor continues a previously-entered instruction that has not yet been completed. The processor receives (or continues) the instruction and responsively sends control signals (e.g. through appropriate relays) to mobility system 127 (FIG. 10), e.g. to a power source switch that connects power to an electric motor that drives the plurality of pins on the robot housing parts that, as described above, engage the tube sheet and a steering controller that controls the rotatable part of the housing parts, as described above, to a position responsive to the operator's selection. The robot then moves over the tube sheet surface and, during this movement at 720, acquires a subsequent image. Due to the relatively high frame rate at which the camera acquires images (e.g. thirty frames per second), the prior and subsequent images substantially overlap, so that most of the tube sheet characteristics present in the subsequent image were also present in the immediately prior image. Given the robot's expected rate of linear movement over the tube sheet surface as driven by the mobility system, the change in position of most tube sheet features (in image space) from one image to the next should be within the image dimensions. That is, unless a feature is at an edge of an image in one frame, that same feature should be present in the next subsequent frame, though offset by a distance determined by the robot's rate of movement and the camera's frame rate in a direction determined by the operator's movement instructions.

Upon receiving the subsequent image's data from the camera, the processor, at 722, repeats steps 702-720 for the new image. For the subsequent image received at 704, the existing heat exchanger data at 702 is provided via the prior image data. The processor again locates circular and linear tube sheet characteristics in the new image, in the same manner as it had for the initial image. Upon locating each such identifiable tube sheet characteristic in the subsequent image (in terms of pixel position), the processing circuitry compares the characteristics' pixel positions in the subsequent image with the tube sheet characteristic pixel positions in the immediately preceding acquired image. The robot's actual, average, expected, or maximum speed being known, and the camera's frame rate being known, dividing the latter into the former provides the expected distance the robot can be expected to travel from image to image. The addition of a tolerance, e.g. 5%, 10%, 15% or the like, to the expected distance range produces a threshold distance by which tube sheet characteristics in the subsequent image are correlated to tube sheet characteristics in the prior image. This predetermined threshold is programmed into the program executed by the processor. The processor thus compares the pixel location of each identified tube sheet characteristic in the subsequent image to the pixel positions of each tube sheet characteristic in the initial image. Where a tube sheet characteristic is at a pixel position in the subsequent image that is within the predetermined threshold of the pixel position of the same type of tube sheet characteristic (e.g. open tube or plug tube, as the case may be) in the prior image, but is not within the predetermined threshold with respect to any other tube sheet characteristic of the same type in the prior image, the processor determines that the tube sheet characteristic in the subsequent image is the tube sheet characteristic from the prior image that is within the threshold distance. If multiple tube sheet characteristics from the prior image are within the threshold distance of the characteristic in the subsequent image, the characteristic in the subsequent frame is recorded but is not used to locate the subsequent image. Returning to a characteristic in the subsequent image for which there is only one characteristic within the threshold from the prior image, since the processor has identified the tube sheet characteristic from the prior image in tube sheet space, the processor assigns the tube sheet characteristic in the subsequent image the same identity and stores that tube sheet space identity in association with the image pixel location of the subsequent image in the data stored for this image, as discussed herein. The processor repeats this process for each tube sheet characteristic identified in the subsequent image. Where the processor is able to so identify the tube sheet space identity of at least two tube sheet characteristics of the subsequent image, this locates the subsequent image in tube sheet space, as discussed herein, where these two tube sheet characteristics are the predetermined tube sheet characteristics. If the subsequent image contains any tube sheet characteristics that were not present in or successfully identified within the prior image, the processor attempts to identify those characteristics based on at least two of the identified characteristics, as discussed herein.

Having located the subsequent image, and therefore the robot, in tube sheet space, the processor identifies the image's, and therefore the robot's, general orientation in tube sheet space and corrects that orientation for image distortion, as discussed herein. The processor determines the tube sheet space position of the end effector and its tool, as described above and further below, and updates the representation of the image and the end effector/tool in the tube sheet representation presented at the user interface 60 (FIG. 14) display as indicated at FIG. 6A. The processor repeats this procedure as the robot moves and repeatedly acquires subsequent images, thereby causing the image/end effector/tool representation at FIG. 6A to repeatedly update in position on the tube sheet representation of FIG. 6A at the user interface display, providing a representation of the robot's movement that tracks the robot's actual movement on the tube sheet surface. The operator views the robot's movement at the user interface. When the end effector/tool reaches a position over a tube at which the operator desires to deploy the tool, the operator issues an instruction, via the user interface, to the processor to stop the robot's movement. In response, or otherwise if the robot has completed a prior movement instruction without receiving a new movement instruction, the processor issues corresponding signals to the mobility system, causing the electric motors driving the robot pins and respective movable housing parts to deactivate. If the end effector/tool are properly located, the operator then issues an instruction to deploy the tool in the desired tube opening, as discussed above.

The operator repeats this process until the operator has deployed the tool in all tube openings of interest, with the result that the processing circuitry has stored at 54 (FIG. 14) the test results in association with the respective tube opening identities (and, in some embodiments, the tracking images) as discussed above. The operator may then control the robot's movement on the tube sheet surface to move to a position proximate one of the manways 121, from which the operator may access the tube sheet area to manually remove the robot.

As described above, camera 124 may send image data 200 to processing circuitry 50 (FIG. 14) dynamically, so that the image data is received dynamically, e.g. in real time or near real time. In addition, or in other embodiments, the camera may store images in memory associated with the camera as the camera acquires the images, for later download to the processing circuitry, so that, from the perspective of the processing circuitry, the image frames are prerecorded image data. Camera 124 may capture image data 200 as fixed images or as discrete frames of a moving image captured by camera 124, and the terms “frame” and “frame rate,” as used herein, should be understood to encompass both approaches.

In some example embodiments, camera 124 may include a wide angle or ultra-wide angle lens 125 (FIG. 2A), such as a fish eye lens, to maximize the viewable area in each frame of image data 200 and increase the number of tube locations 202 (FIGS. 3A-4B, 8) in each frame. Wide angle lens 125 may introduce visual distortion, such as a hemispherical image distortion. Processing circuitry 50 (FIG. 14) may apply an undistort filter to image data 200 to correct the image distortion. The undistort filter may include one or more filter coefficients, e.g. de-warping coefficients, which are calibrated to the specific camera 124 and/or lens used to capture image data 200. Processing circuitry 50 (FIG. 14) may generate a flattened image, such as flattened image 220 depicted in FIG. 3B, based the application of the undistort filter on image data 200. Flattening image data 200 allows processing circuitry 50 (FIG. 14) to more easily determine heat exchanger characteristics, such as circular tube locations 202 or straight tubes 110, which may appear as ovals or curved lines, respectively, in image data 200.

In some example embodiments, the image quality within the interior of heat exchanger 100 may be poor or unreliable due to the harsh environment in which the tube sheet is disposed. Thus, for example, lighting in image data 200 (FIG. 3A) may not be uniform, thereby causing areas of insufficient light and/or areas with excessive light, e.g. glare from a light source associated with the robot, that may, in turn, cause dark areas or washout in an image acquired by the camera 124. In some example embodiments, processing circuitry 50 (FIG. 14) may be configured to apply light compensation to image data 200 (FIG. 3A) or to the flattened image 220 (FIG. 3B) to provide increased detail for analysis. In an example embodiment, the light compensation includes applying a gamma filter, such as a two-pass gamma filter, to a frame of image data 200 of flattened image 220 at a high gamma correction, such as the high gamma compensated image data 300 depicted in FIG. 4A, and again at a low gamma correction, such as the low gamma compensated image 320 depicted in FIG. 4B. The processor may compare and/or add the high gamma compensated image data 300 to the low gamma compensated image data 320, and/or the image data 200 or the flattened image data 220. The high gamma compensated image data 300 and the low gamma compensated image data 320 may highlight different areas of image data 200 or flattened image 220 due to the differences in lighting, thus enabling further details in the image data to be detected for identification of heat exchanger characteristics. Although, a two-pass gamma filter is described, one of ordinary skill in the art would immediately appreciate that any number of gamma filter passes may be applied at different gamma correction levels to detect further details in the image data.

FIG. 5 illustrates an example image 400 acquired by the robot camera in the method described herein that includes heat exchanger characteristics, e.g. tube locations 402 (tube openings 202 as in FIGS. 3A-4B, 8). Because the image is defined by the robot camera's image sensor and lens, the relationship between image 400 and the tube sheet surface can be described by the camera's position, and more specifically the position of the camera sensor and lens, with respect to the tube sheet surface. The sensor and lens orientation with respect to the tube sheet surface can be described, in turn, in terms of a relationship between the lens's optical axis (or the camera's field of view axis 401) and the tube sheet surface, more specifically (a) a distance between the lens/sensor assembly and the tube sheet surface, e.g. a distance between the lens and the tube sheet surface, (b) a pitch angle between a first plane perpendicular to the tube sheet surface plane and a projection of the axis in a second plane perpendicular to the tube sheet surface plane and the first plane, (c) a yaw angle between the second plane and a projection of the camera axis in the first plane, (d) the lens's and sensor's rotational position about the axis 401, e.g. a roll angle about the axis in a plane perpendicular to the axis between a predetermined reference line in the plane and a predetermined reference line in the image, and (e) the position in tube sheet space of the intersection between camera axis 401 and the tube sheet surface. The mobility system, and in particular the pins thereof that engage the tube sheet surface and hold the robot and the camera at a constant vertical distance from the tube sheet surface, maintains the camera lens and the sensor at respective predetermined distances above the tube sheet surface and the camera field of view axis aligned vertically with respect to the horizontal tube sheet surface. Thus, the distance is known and constant, and the pitch and yaw angles are zero. Accordingly, the unknown aspects of the camera's disposition or position with respect to the tube sheet are its location (e.g. as defined by the location of the camera axis intersection with the tube sheet surface) and its orientation, and thus the image's orientation, with respect to the tube sheet surface, where the camera's orientation resolves to the camera's (and, thus, the image's) rotational position about camera axis 401. As described above and in more detail below, the processing circuitry does not directly determine the intersection of the camera axis and the tube sheet surface but, instead, identifies the location of two or more predetermined features in the image and associates the axis 401 position in image space with the known positions of the same features in tube sheet space. The correlation of the locations of at least two tube sheet characteristics from image space to tube sheet space locates the entire image in tube sheet space, thereby enabling correlation of all features identified from image space to tube sheet space. Because the robot's rotational position about axis 401 with respect to image space is known through calibration, this also generally identifies the robot's rotational position about that axis position in tube sheet space, such position being further adjustable to correct for image distortion error. The discussion herein provides one or more examples of methods by which image features are located in tube sheet surface, or tube sheet surface map, space, to thereby enable location (in tube sheet map space) of all other identified image features. It should be understood, however, that such examples are provided for purposes of illustration only and that other methodologies may be used. In other embodiments, e.g., one or more of the camera distance from the tube sheet surface, the camera axis pitch with respect to a predetermined reference in tube sheet surface space, and the resulting camera axis yaw, may not be consistent from image to image and may be resolved by the processing circuitry based on information about features identified in the image and/or by information provided by the robot.

As discussed above, image space distortions can create error in the processor's location of the robot's orientation in tube sheet space. As described above, the processor determines the locations of the tube centers in the image through triangulation based on the positions of two known tube characteristics. The translation of each triangle into tube sheet space assumes that the representation of the tube sheet surface in the image is undistorted, so that the relationships among the features in the image are the same as the relationships among those same features on the tube sheet surface. Distortion in the image, however, can impart differences in those relationships, as between the image and the tube sheet, with the result that the correlation between one or more tube sheet characteristics in the image to tube sheet characteristics in tube sheet space may be incorrect, and there may be error in the identification of line 502 in tube sheet space. This, in turn, can translate into error in identifying the location of the end effector and tool at 503. Since the distance between robot center axis 401 and the end effector/tool 503 can be large relative to the dimensions of image 400, this error can propagate to such a degree that the end effector/tool position illustrated in FIG. 6A can be off by an entire row or column of tubes.

To resolve such error, the processor adjusts the position of reference line 502, and therefore of ray 504, in the display 500 of FIG. 6A based on distortion error detected in the image 400 of FIG. 5. The analysis is based on the assignment of linearly sequential tube sheet tube openings as either columns or rows. Referring to FIG. 6A, tube sheet opening columns are disposed vertically in the Figure, whereas rows are horizontal. As discussed above regarding the definition of the reference coordinates in tube sheet space, the particular orientation of linear sequential tube sheet openings that is determined to be the column direction or the row direction on a given tube sheet is immaterial, provided all columns are at the same predetermined angle with respect to all rows. In the example discussed herein, the angle is 90°, but it will be apparent from the present disclosure that other angular orientations are possible. Referring again to FIG. 5, the processor finds the tube sheet opening in the image whose center (a) is closest to the robot camera's center axis intersection 401 with the tube sheet and (b) is on a line, defined by tube opening centers of a column of tube openings, that crosses line 502. As will be apparent from the discussion herein, the present analysis could also operate based on a row line. In this example, the analysis relies on a column line because the adjustment angle to line 502 is determined with reference to a line parallel to the column center lines. Thus, in an embodiment in which the adjustment angle is determined with reference to a line parallel to the row center lines, the criteria for selecting a tube sheet center point for analysis may rely on a row line.

In FIG. 5, the tube center meeting this criteria is that of the tube opening immediately below and to the left of point 401, the center of which is indicated at 404. The processor selects one of the two tube opening centers adjacent the selected center 404 in the selected center's same column (i.e. among those tube characteristic centers having the same column number). The choice of which adjacent center is immaterial, but in this example the direction chosen results in the selection of the tube opening center 404 immediately above and to the right of axis 401.

The processor then selects one of the two tube opening centers adjacent the selected center 404 in the selected center's same row (i.e. among those tube characteristic centers having the same row number). The choice of which adjacent center is immaterial, but in this example the direction chosen results in the selection of the tube opening center immediately to the right and below the selected center 404. The processor defines a line 405 in image space extending through the two column centers and a line 407 in image space through the two row centers. The processor then measures the angle Δ between these two lines. Angle Δ could be measured directly between lines 405 and 407, or, e.g., by measuring the angle Θ_{col} between lines 406 and 405, and the angle Θ_{row} between lines 406 and 407, and determining the difference between Θ_{col} and Θ_{row}. Since the tube opening row lines and column lines in tube sheet space are always offset by 90° (or 270°, depending on the measurement direction, but in either event the “expected angle”), deviation from a 90° offset between lines 405 and 407 in image 400 is due to distortion in the image. In one or more embodiments, the processor directly measures the angle between lines 405 and 407 in the same direction as the expected angle is measured, compares the measured angle to the expected angle, and defines an offset adjustment angle, as discussed below, to be equal to one-half the difference between the expected angle and the measured angle. The 0.5 weighting factor was determined by trial and error to provide a desired distortion resolution, but it should be understood that this factor may be adjusted if desired. If the measured angle is less than the expected angle, the offset adjustment angle is negative, indicating a clockwise shift in lines 502 and 504 in FIGS. 6A and 6B, as discussed in more detail below. If the measured angle is greater than the expected angle, the offset adjustment angle is positive, indicating a counterclockwise shift in lines 502 and 504 in FIGS. 6A and 6B.

In other embodiments, the distortion measurement, and its compensatory offset adjustment angle, are determined based on an approximation of a column line 405 that incorporates additional tube centers for the selected column whose centers are visible in image 400 and additional tube centers for the selected row whose centers are visible in image 400. In one or more such embodiments, the processor defines line 405 by applying a best fit algorithm to all such visible column tube centers in the selected column (in image space) and defines line 407 by applying a best fit algorithm to all such visible row tube centers in the selected row (in image space). The processor then directly measures the angle between lines 405 and 407 in the same direction as the expected angle is measured (or by determining Θ_{col} and Θ_{row} and the difference between those angles, as discussed above), compares the measured difference angle to the expected angle, and defines an offset adjustment angle, similarly as discussed above and below, to be equal to one-half the difference between the expected angle and the measured angle, weighted by a factor that depends on a ratio of the number of tube sheet characteristic points that contributed to the definition of row line 407 to the number of points that contributed to column line 405. Again, the default factor of 0.5 was determined upon trial and error to provide a desirable resolution of distortion when the column and row points contributed evenly. The sign of the offset adjustment angle, again, determines the direction by which lines 502 and 504 are rotated in FIGS. 6A and 6B, as a result.

In other embodiments, the angle between lines 405 and 407 is not measured directly between the two lines but is, instead, measured as the difference between angles Θ_{col} and Θ_{row} measured between line 405 and a line 406 parallel to line 502 that passes through selected tube opening center point 404 and between line 407 and line 406, respectively, where the angle Θ_{col} between line 405 and line 406 is the result of a replication and accumulation of such angles for multiple tube centers in the selected column, and the angle Θ_{row} between line 407 and line 406 is the result of a replication and accumulation of such angles for multiple tube centers in the selected row. An accumulation of offset errors among the tube sheet centers in the selected column and in the selected row increases the confidence in the error determination. For each tube opening in the selected column in image 400 for which a center is within image 400 or is projectable to a determinable position with respect to image 400 (e.g. if the Hough circle transformation determines a circle center outside the image for a circle only partially visible in the image) for the tube openings above and below the selected tube opening in the selected opening's column (for purposes of this discussion, there are four such tube opening centers in image 400: the selected tube opening center 404 and the respective tube opening centers above and below the selected center 404 as indicated by column line 405), the processor defines a line 406 parallel to line 502 and extending through that tube opening center, a line 405 as a best fit line defined by the selected tube center point 404 and all other (in this instance, three) tube center points in the column in or projected from the image (as discussed above), and an angle (Θ_{Col}) extending from that line 406 in the clockwise direction to that line 405. For each tube opening in the selected row in image 400 for which a center is within or projectable from the image for the tube openings to the right and left of that tube opening (there are five such tube opening centers in or projectable from image 400 along row 407: the selected tube opening center 404 and the two tube opening centers in the row both to the left and the right of the selected tube opening center 404), the processor defines a line 406 parallel to line 502 and extending through the selected tube opening center, a line 407 as a best fit line defined by the selected tube center point 404 and all other (in this instance, four) tube center points in the row in or projected from the image (as discussed above), and an angle (Θ_{Row}) extending from that line 406 in the clockwise direction to that line 407. For each of the three other column tube centers within the same column as the originally selected column tube center, the processor determines an angle Θ_{Col} specific to that tube opening as the now-selected opening, in the manner as described above. For each of the two other row tube centers within the same row as the originally selected row tube center, the processor determines an angle Θ_{Row} specific to that tube opening as the now-selected opening, in the manner as described above. The processor averages the four values of Θ_{Col} and averages the two values of Θ_{Row}, where the average function is represented at Equation 1.

Processing circuitry 50 removes outliers in Θ_{col} and Θ_{row}, such as by applying Chauvenet's criterion. In some examples, Θ_{col} and Θ_{row} angles greater than a predetermined threshold, such as two standard deviations, may be removed from processing, as an outlier not indicative of a true heat exchanger characteristic location.

$$\overline{θ} = aTan 2 ( \frac{1}{n} {\sum }_{j = 1}^{n} sin θ , \frac{1}{n} {\sum }_{j = 1}^{n} Cos θ ) \qquad EQN . 1$$

The processor executes Equation 2 to thereby determine the absolute value of the difference, Δ, between the average column angle, θ̅_{Col}, and the average row angle, θ̅_{Row}, produced by Equation 1. As noted above, this angle should be 90°, in the absence of image distortion.

∥θ̅_{Row}−θ̅_{Col}|=Δ EQN. 2

Since Δ can range between 0° and 360°, if Δ is greater than 180°, the processor converts Δ to its corresponding angle below 180° according to Equations 3a and 3b, resulting in the angle σ. As will be apparent below, these steps are not needed for Equation 4, but for Equations 5a and 5b, the results of which indicate whether the angle adjustment should be additive or subtractive, the angle should be converted to a value less than 180°.

Δ>180⇒σ=360−Δ EQN. 3a

Δ<180⇒σ=Δ EQN. 3b

The processor executes Equation 4 to determine the remainder, λ, from the numerical division of σ by the expected angle.

λ=σ mod ≮_tubesheet. EQN. 4

The modulo operation result (λ) describes the angle by which the angular offset between the column and row in the image differs from the angular offset between the same column and row in image space. In this example, then, λ describes the angle by which the angular offset between the column and row in the image differs from 90°. It does not, however, indicate whether that angular difference from 90° is positive or negative. The processor, executing Equations 5a/5b, introduces the proper sign (i.e. indicating the direction of offset from the expected angle) and halves the result. This is, then, the offset adjustment angle.

$$\begin{matrix}λ = σ ⇒ \frac{{∢}_{t} - λ}{2} & EQN . 5 a \\ λ \neq σ ⇒ \frac{λ}{2} * - 1 & EQN . 5 b\end{matrix}$$

As in the first two embodiments, the default weighting factor is 0.5. As in the second embodiment, the weighting factor can be modified based on the ratio of the number of tube characteristic column center points used to determine line 405 in the best fit analysis to the number of tube characteristic row center points used to determine line 407. The processor determines an error factor equal to one-half the ratio of the number of Θ_{Col} angles utilized in the above analysis to the number of Θ_{Row} angles utilized in the above analysis. If the error factor is less than 1, the processor keeps the offset adjustment angle unchanged. If the error factor is greater than 1, the processor multiplies the offset adjustment angle by the error factor.

Returning to FIGS. 6A and 6B, having determined the offset adjustment angle (which, as noted above, may be positive or negative), the processor rotates the lines 502 and 504 about axis 401, which is normal to the tube sheet surface, by the offset adjustment angle, while keeping the display of the tube sheet surface still, in the clockwise direction if the offset adjustment angle is negative and in the counterclockwise direction if the offset adjustment angle is positive.

As discussed above, the adjustment to the rotation angle and/or orientation angle may cause the determination of the end effector position in FIG. 6A to be corrected, since the determination of the end effector position is based on the determined position and orientation of the robot.

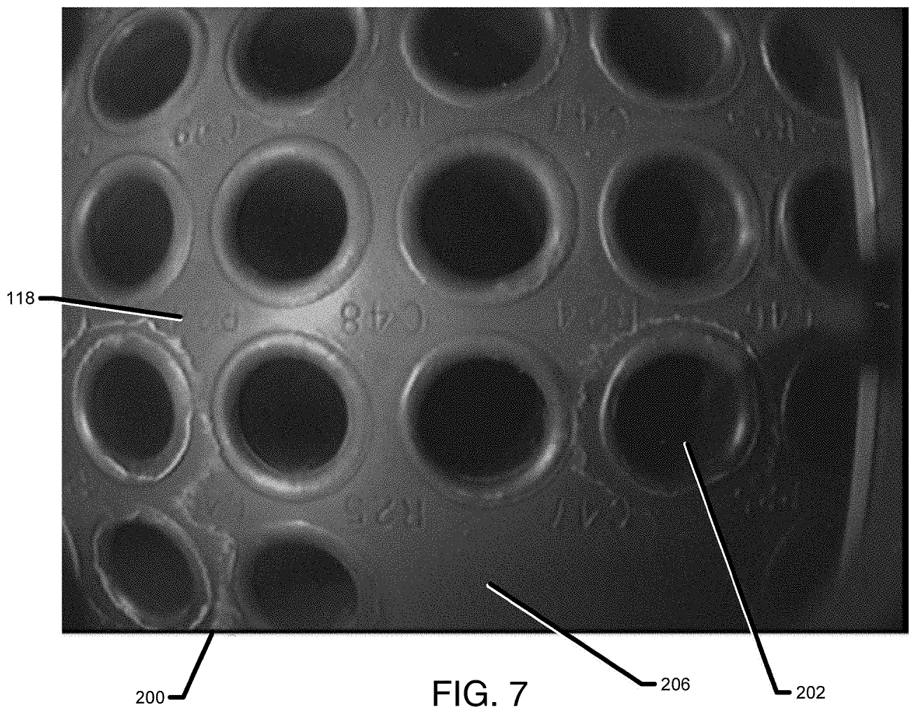

As discussed above, and referring to FIGS. 6A and 14, processing circuitry 50 determines a location of the image data 400 in the map space, or tube sheet space, which may be a current location of robot 120 and/or camera 124 when image data 400 is received and processed dynamically, based on the heat exchanger characteristics. Processing circuitry 50 calculates a location based on the starting location data, e.g. the identified or predetermined heat exchanger characteristics, and/or other known heat exchanger characteristics locations, such as previously identified heat exchanger characteristic locations from previous iterations of the alignment and identification process. Processing circuitry 50 calculates the position of image and/or robot 120 by comparing the known heat exchanger characteristic locations to heat exchanger data stored in memory, such as storage device 54 referenced in FIG. 14 below. The heat exchanger data may include a map of heat exchanger characteristics, such as a tube sheet map 500 shown in FIG. 6A. The tube sheet map details the known layout of the tube sheet 118 and, in some instances relationships to heat exchange features, such as access points and major components. Tube sheet map 500 includes the location of each tube 110 in tube sheet 118. Tube sheet map 500 depicts hot leg 102, cold leg 104, and divider plate 103. In some example embodiments, tube sheet map 500 depicts the locations of inlet piping 108, outlet piping 112, and/or manways 121. The locations of tubes 110 indicates that the location is a stay location 206, as depicted in FIG. 7, for which there is no penetration of the tube sheet 118, a plug tube 208, as depicted in FIG. 8, which is at least partially plugged, of an unaltered tube location, or the like. Additionally, tube sheet map 500 may include locations of tubes 110 with distinct characteristics, such as locations of one or more tubes along the periphery of the tube sheet 118 or divider plate 103 which may have a distinct tube location pattern. The operator may use one or more of the unique heat exchanger characteristics, such as plug tubes, stay tubes, periphery tubes, or the like to verify the identification of the tube locations 402 during a calibration check and/or during operation, e.g. the heat exchanger inspection.

Processing circuitry 50 identifies one or more heat exchanger characteristics by comparing the unknown heat exchanger characteristics and the known heat exchanger characteristics in image 400 of FIG. 5 to the heat exchanger data, e.g. the tube sheet map 500 of FIG. 6A. As discussed above, the processing circuitry anchors and orients each image to the tube sheet map based on two or more known heat exchanger characteristics in the image data 400 and measurement of the image distortion. Processing circuitry 50 identifies unknown tube locations based on correlating the heat exchanger characteristics of the tube sheet map matching the positions of the unknown heat exchanger characteristics in the oriented image data 400. Processing circuitry 50 then adds the identified tube locations to the known tube locations for subsequent images 400, e.g. the identification of the heat exchanger characteristics may be saved in the image and map spaces for subsequent use. Additionally, the calculated distortion error. Processing circuitry 50 may confirm the identity of the heat exchanger characteristic in the current frame, by comparing the determined identity of the heat exchanger characteristics over two or more frames, as discussed below.

As discussed above, processing circuitry 50 tracks, by storing to memory, heat exchanger characteristics from a previous frame and uses the location of the previously identified heat exchanger characteristics to determine unknown or unidentified heat exchanger characteristics. In an example embodiment, processing circuitry 50 compares the current image frame to one or more previous frames. The known heat exchanger characteristics in a current image frame may be determined by being within a predetermined threshold, such as 1 radii, 2 radii, or the like, for circle detection of a tube location 402 or a width of a tube 110 in line detection of tubes 118. The threshold may be selected based on the frame rate of the image data and/or the speed at which robot 120 (FIG. 1) moves, e.g. a maximum expected speed, such that the heat exchanger characteristic within the threshold between two adjacent images is likely to be the same heat exchanger characteristic. Processing circuitry 50 may identify the heat exchanger characteristics of the current image based on the previously identified heat exchanger characteristics of the previous image frame which satisfy the predetermined threshold. The processing circuitry may determine detected heat exchanger characteristics which exceed the threshold to be unknown heat exchanger characteristics for identification, as discussed above. In some example embodiments, processing circuitry 50 removes heat exchanger characteristics from processing that are not substantially within image 400, such as less than half of a detected circle, from processing, to prevent errors.

In an example embodiment in which few tubes, e.g. three tubes, four tubes, or the like, are found in the current frame, the theta angle analysis from a predetermined number of previous frames, such as 1 frame, 3 frames, or the like, may be averaged and used for adjustment of the rotation angle of image 400. In some example embodiments, processing circuitry 50 verifies the identified heat exchanger characteristics throughout the inspection. Processing circuitry 50 is configured to relabel any heat exchanger characteristic that is determined to be mis-identified. For example, if the heat exchanger characteristic is identified a predetermined number of times, such as three times, five times, a majority or time, or the like, differently than the current identification, the heat exchanger characteristic is identified with the new identification.

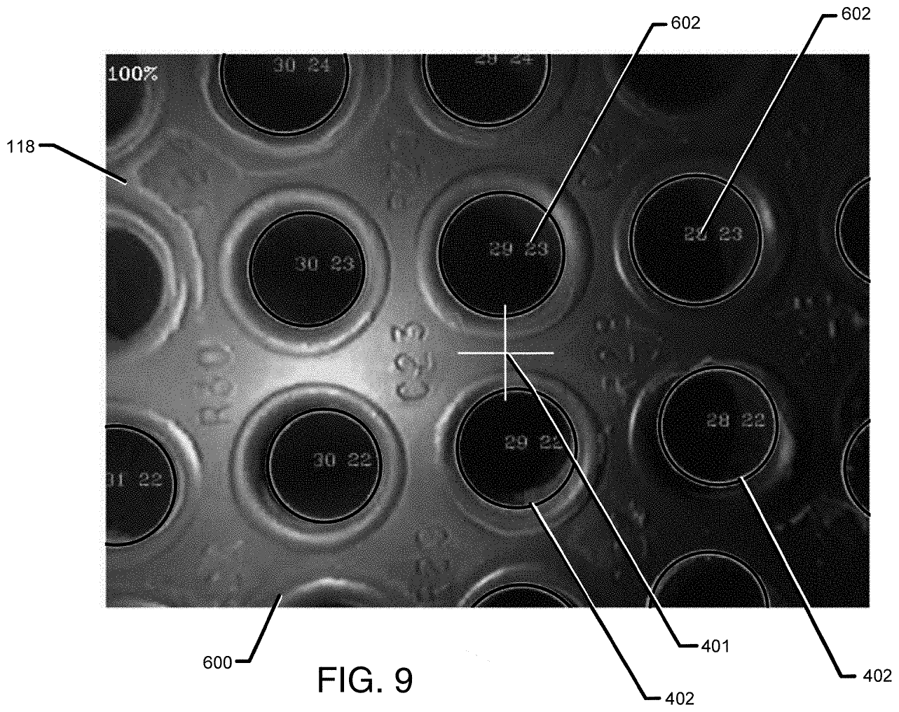

FIG. 9 illustrates an example embodiment of a tube sheet with determined tube locations 402. The identity of each determined tube location 402 is depicted numerically by an identifier 602. In the depicted example, each detected tube location 402 includes a two number identifier 602, such as 30, 23. The first number of the identifier 602 is the row, e.g. row 30, and the second number of the identifier 602 is the column, e.g. column 23. As discussed above, the truth table stores each tube mark in association with the four digit row/column number for the corresponding tube.

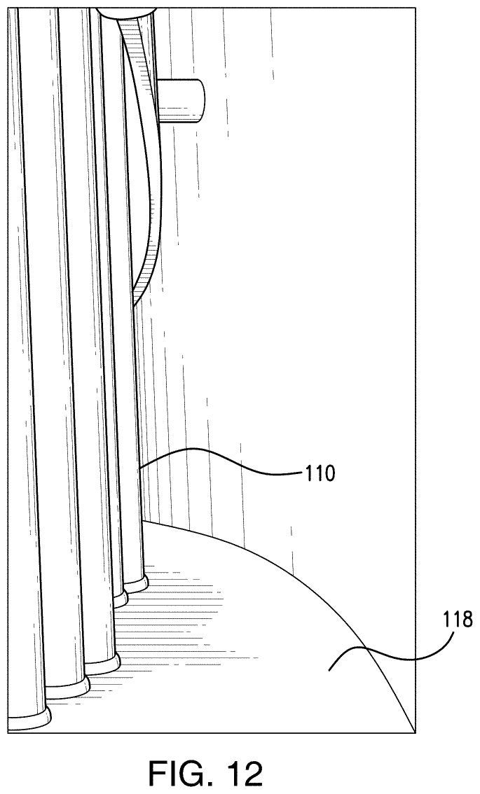

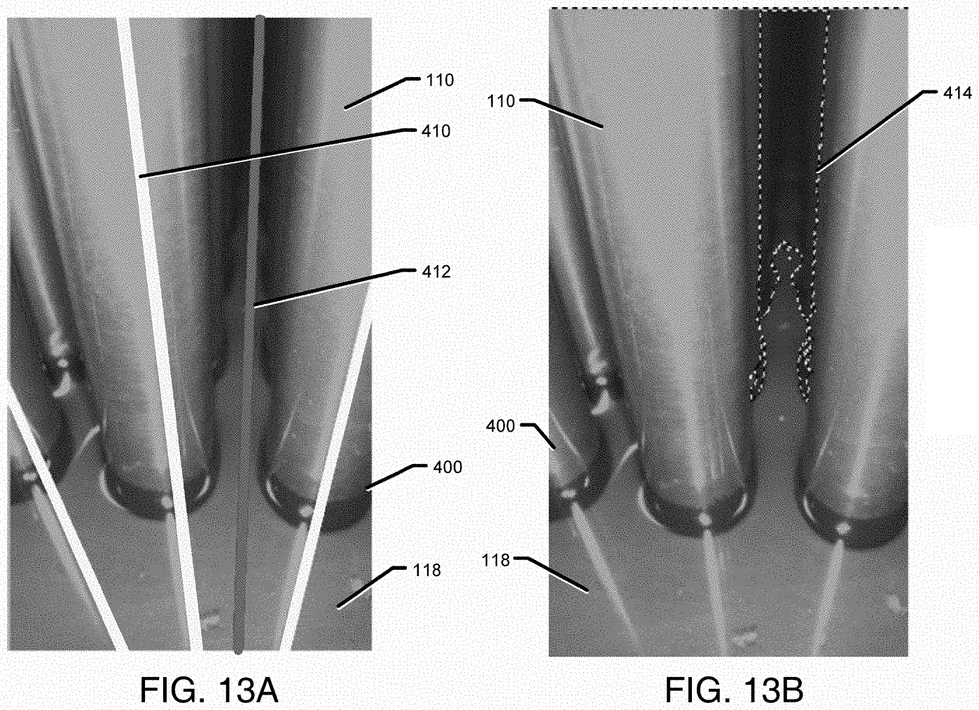

Although the above process is discussed primarily in the context of inspecting tube sheet 118, other aspects of heat exchanger 100 may also be inspected using this process, such as the interface of tubes 110 and tube sheet 118 on the heat sink side 106 of the heat exchanger, such as depicted in FIG. 11. In an example embodiment, such as depicted in FIG. 10, robot 120 includes a mobility system 127 including one or more wheels, tracks, or the like. Robot 120 is configured to move along tube sheet 118, heat exchanger walls, or the like, such as by driving on the wheels or tracks. Camera 124, in such an embodiment, is forward facing and captures image data ahead of robot 120. Processing circuitry 50 may utilize distinct tube 110 arrangements, such as unique point tubes, e.g. tubes 110 at the end of a column of row, to determine a location and identify heat exchanger characteristics. An example of a tube 110 tube sheet 118 interface including unique point tubes is illustrated in FIG. 12 depicting tubes 110 at the end of a row of tubes 110. In some example embodiments, mobility system 127 may also be used for location determination, such as distance and/or direction traveled from a known location based on wheel movement, inertial measurements, or the like.

As depicted In FIG. 13, processing circuitry 50 determines heat exchanger characteristics, such tubes 110 and spaces between tubes 110 based on searching for lines, such as by applying a Hough line transform. In the depicted embodiment, image 400 includes lighter lines 410, indicative of a tube 110, and darker lines 412 indicative of a space between tubes 110. Additionally or alternatively, processing circuitry 50 may apply an image processing method, such as stitching and registration, morphologic filtering, thresholding, pixel counting, segmentation, edge detection, color analysis, blob detection, pattern recognition, or the like, as depicted in FIG. 13B to determine additional heat exchanger characteristics, such as a tube sheet pattern 414. Processing circuitry 50 utilizes the heat exchanger characteristics, e.g. light lines 410, dark lines 412, and/or tube sheet pattern 414, to determine a location in heat exchanger 100 and identify the heat exchanger characteristics, by comparing the determined heat exchanger characteristics to a heat exchanger map, similar to the process discussed above.

### Example Apparatus

An example embodiment of the invention will now be described with reference to FIG. 14, which illustrates certain elements of an apparatus for heat exchanger inspection according to an example embodiment. The apparatus of FIG. 14 may be employed, for example, on a robot (e.g. robot 120 of FIGS. 2A, 2B, and/or 10) or a variety of other devices (such as, for example, computer terminal, a network device, server, proxy, or the like. Alternatively, embodiments may be employed on a combination of devices. Accordingly, some embodiments of the present invention may be embodied wholly at a single device (e.g. robot 120 or computing terminal) or by devices in a client/server relationship (e.g. the computing terminal and robot 120). Furthermore, it should be noted that the devices or elements described below may not be mandatory and thus some may be omitted in certain embodiments.

An apparatus configured for heat exchanger inspection is provided. The apparatus may be an embodiment of inspection module 44 or a device hosting inspection module 44. In an example embodiment, the apparatus may include or otherwise be in communication with processing circuitry 50 that is configured to perform data processing, application execution and other processing and management services. In one embodiment, processing circuitry 50 may include a storage device 54 and a processor 52 that are in communication with or otherwise control a user interface 60 and a device interface 62. As such, processing circuitry 50 is embodied as a circuit chip (e.g. an integrated circuit chip) configured (e.g. with hardware, software or a combination of hardware and software) to perform operations described herein. However, in some embodiments, processing circuitry 50 may be embodied as a portion of a server, computer, laptop, workstation or even one of various mobile computing devices. In situations where processing circuitry 50 is embodied as a server or at a remotely located computing device, user interface 60 may be disposed at another device (e.g. at a computer terminal or client device) in communication with processing circuitry 50 via device interface 62 and/or a network (e.g. network 30).

User interface 60 is in communication with processing circuitry 50 to receive an indication of a user input at user interface 60 and/or to provide an audible, visual, mechanical or other output to the user. As such, user interface 60 may include, for example, a keyboard, a mouse, a joystick, a display, a touch screen, a microphone, a speaker, mobile device, or other input/output mechanisms. In embodiments where the apparatus is embodied at a server or other network entity, user interface 60 may be limited or even eliminated in some cases. Alternatively, as indicated above, user interface 60 may be remotely located.

Device interface 62 may include one or more interface mechanisms for enabling communication with other devices and/or networks. In some cases, device interface 62 may be any means such as a device or circuitry embodied in hardware, software, or a combination of hardware and software that is configured to receive and/or transmit data from/to a network and/or any other device or module in communication with processing circuitry 50. In this regard, device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, storage device 54 may include one or more non-transitory storage or memory devices such as, for example, volatile and/or non-volatile memory that may be either fixed or removable. Storage device 54 may be configured to store information, data, applications, instructions or the like for enabling the apparatus to carry out various functions in accordance with example embodiments of the present invention. For example, storage device 54 could be configured to buffer input data for processing by processor 52. Additionally or alternatively, storage device 54 could be configured to store instructions for execution by processor 52. As yet another alternative, storage device 54 may include one of a plurality of databases (e.g. database server 42) that may store a variety of files, contents or data sets. Among contents of the storage device 54, applications (e.g. client application 22 or server application 44) may be stored for execution by processor 52 in order to carry out the functionality associated with each respective application.

Processor 52 may be embodied in a number of different ways. For example, processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, processor 52 may be configured to execute instructions stored in storage device 54 or otherwise accessible to processor 52. As such, whether configured by hardware or software methods, or by a combination thereof, processor 52 may represent an entity (e.g. physically embodied in circuitry) capable of performing operations according to embodiments of the present invention while configured accordingly. Thus, for example, when processor 52 is embodied as an ASIC, FPGA or the like, processor 52 may be specifically configured hardware for conducting the operations described herein. Alternatively, as another example, when processor 52 is embodied as an executor of software instructions, the instructions may specifically configure processor 52 to perform the operations described herein.

In an example embodiment, processor 52 (or processing circuitry 50) may be embodied as, include or otherwise control the inspection module 44, which may be any means, such as, a device or circuitry operating in accordance with software or otherwise embodied in hardware or a combination of hardware and software (e.g. processor 52 operating under software control, processor 52 embodied as an ASIC or FPGA specifically configured to perform the operations described herein, or a combination thereof) thereby configuring the device or circuitry to perform the corresponding functions of inspection module 44 as described below.

In an example embodiment, processing circuitry 50 may include or otherwise be in communication with camera 124. The camera 124 may be a digital camera configured to capture image data associated with the surrounding environment. The image data may be one or more fixed images or a moving image.

Inspection module 44 manager may include tools to facilitate distributed heat exchanger inspections via network 30. In an example embodiment inspection module 44 is configured to receive the image data from the camera, determine one or more heat exchanger characteristics in the image data, compare the one or more heat exchanger characteristics to heat exchanger data, determine a current location of the robot based on the comparison of the one or more heat exchanger characteristics to the heat exchanger data, and identify the heat exchanger characteristic based on the current location.

From a technical perspective, inspection module 44 described above may be used to support some or all of the operations described above. As such, the platform described in FIG. 14 may be used to facilitate the implementation of several computer program and/or network communication based interactions. As an example, FIG. 15 is a flowchart of a method and program product according to an example embodiment of the invention, as described above. It will be understood that each block of the flowchart, and combinations of blocks in the flowchart, may be implemented by various means, such as hardware, firmware, processor, circuitry and/or other devices associated with execution of software including one or more computer program instructions. For example, one or more of the procedures described above may be embodied by computer program instructions. In this regard, the computer program instructions which embody the procedures described above may be stored by a memory device of a user terminal, robot 120, or the like and executed by a processor therein. As will be appreciated, any such computer program instructions may be loaded onto a computer or other programmable apparatus (e.g. hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An automated system for heat exchanger inspection comprising:
a robot having a body and a mobility system configured to engage and move the robot over a surface of the heat exchanger;
a camera disposed on the body and configured to capture image data including at least a portion of the heat exchanger surface; and
processing circuitry configured to:
receive the image data from the camera;
determine a plurality of heat exchanger characteristics in the image data;
compare the plurality of heat exchanger characteristics to heat exchanger data;
determine a current location and an orientation angle of the robot on the heat exchanger surface with respect to a reference based on the comparison of the plurality of heat exchanger characteristics to the heat exchanger data;
identify the plurality of heat exchanger characteristics based on the current location;
measure distortion in the image;
adjust the orientation angle of the robot based upon the measured distortion; and
determine an end effector position with respect to the heat exchanger based on the current location and the orientation angle.

2. The system of claim 1, wherein the processing circuitry is further configured to:
receive a starting location data for the robot.

3. The system of claim 1, wherein the processing circuitry is further configured to:
apply an undistort filter to the image data.

4. The system of claim 1, wherein the processing circuitry is further configured to:
apply light compensation to the image data.

5. The system of claim 4, wherein the light compensation comprises a high gamma compensation and a low gamma compensation.

6. The system of claim 1, wherein
determining the end effector position is further based on a predetermined end effector offset from the camera.

7. The system of claim 1, wherein adjusting the orientation angle comprises determining the plurality of angles between two or more heat exchanger characteristics.

8. The system of claim 7, wherein the adjusting the orientation angle comprises averaging the plurality of angles between two or more heat exchanger characteristics.

9. The system of claim 1, wherein identifying the plurality of heat exchanger characteristics comprises comparing an unknown heat exchanger characteristic to a known heat exchanger characteristic.

10. The system of claim 1, wherein the processing circuitry is further configured to:
confirm the identity of the plurality of heat exchanger characteristic based on two or more image data frames at two or more locations.

11. An apparatus for heat exchanger inspections comprising processing circuitry configured to:
receive image data from a camera associated with a robot so that a field of view of the camera encompasses a surface of the heat exchanger;
determine a plurality of heat exchanger characteristics in the image data;
compare the plurality of heat exchanger characteristics to data describing the heat exchanger surface;
determine a current location on the heat exchanger surface, and an orientation angle with respect to a reference position on the heat exchanger surface, of the robot based on the comparison of the plurality of heat exchanger characteristics to the heat exchanger surface data;
identify the plurality of heat exchanger characteristic based on the current location;
measure distortion in the image data;
adjust the orientation angle of the robot based upon the measured distortion; and
determine a position of an end effector attached to the robot based on the current location and the orientation angle.

12. The apparatus of claim 11, wherein the processing circuitry is further configured to:
receive a starting location data for the robot.

13. The apparatus of claim 11, wherein the processing circuitry is further configured to:
apply an undistort filter to the image data.

14. The apparatus of claim 11, wherein the processing circuitry is further configured to:
apply light compensation to the image data.

15. The apparatus of claim 14, wherein the light compensation comprises a high gamma compensation and a low gamma compensation.

16. The apparatus of claim 11, wherein determining the end effector position is further based on a predetermined end effector offset from the camera.

17. The apparatus of claim 11, wherein measuring distortion comprises determining a first angle defined by intersecting lines defined by a plurality of features in the image data and comparing the first angle to a second angle defined by intersecting lines defined by the same plurality of features on the heat exchanger surface.

18. A method for inspecting a heat exchanger comprising:
receiving image data from a camera associated with a robot so that a field of view of the camera encompasses a surface of the heat exchanger;
determining a plurality of heat exchanger characteristics in the image data;
comparing the plurality of heat exchanger characteristics to data describing the heat exchanger surface;
determining a current location on the heat exchanger surface, and an orientation angle with respect to a reference position on the heat exchanger surface, of the robot based on the comparison of the plurality of heat exchanger characteristics to the heat exchanger data;
identifying the plurality of heat exchanger characteristic based on the current location;
measuring distortion in the image data;
adjusting the orientation angle of the robot based upon the measured distortion; and
determining an end effector position based on the current location and the orientation angle.

19. A method of inspecting a heat exchanger, comprising:
disposing a camera on a surface of the heat exchanger;
acquiring a first image of the heat exchanger surface by the camera;
identifying in the first image at least two first features of the heat exchanger surface, where respective positions of the at least two first features on the heat exchanger surface are known;
identifying in the first image a plurality of second features of the heat exchanger surface;
determining respective positions of the plurality of second features on the heat exchanger surface based upon the respective positions of the at least two first features on the heat exchanger surface;
moving the camera on the heat exchanger surface;
acquiring a second image of the heat exchanger surface by the camera;
identifying at least two features of the heat exchanger surface in the second image; and
correlating the at least two features of the heat exchanger surface in the second image to respective features of the heat exchanger surface identified in the first image based on a comparison of the second image to the first image.

20. The method as in claim 19, comprising, after the step of identifying the at least two first features, the step of estimating a position of the camera on the heat exchanger surface based on a predetermined positional relationship between the camera and the first image.

21. The method as in claim 20, comprising, after the step of estimating the position of the camera, the steps of measuring distortion in the first image and adjusting the estimated position of the camera based on the measured distortion.

22. The method as in claim 21, wherein the step of measuring distortion comprises identifying a first relationship among respective positions in the first image of a plurality of third features of the heat exchanger surface, identifying a second relationship among respective positions on the heat exchanger surface of the plurality of third features of the heat exchanger surface, and comparing the first relationship to the second relationship.

23. The method as in claim 22, wherein the plurality of third features comprise the at least two first features.

24. The method as in claim 23, wherein the plurality of third features comprise at least one of the plurality of second features.

25. The method as in claim 22, wherein the first relationship is an angle between a first line defined in the first image by a first at least two of the third features and a second line defined in the first image by a second at least two of the third features, and wherein the second relationship is an angle between a third line defined on the heat exchanger surface by the first at least two third features and a fourth line defined on the heat exchanger surface by the second at least two third features.

26. The method as in claim 25, wherein the comparing step comprises determining a difference between the first relationship angle and the second relationship angle.

27. The method as in claim 26, wherein the step of adjusting the estimated position of the camera is based on the difference.

28. A method of inspecting a heat exchanger, comprising:
disposing a camera on a surface of the heat exchanger;
acquiring an image of the heat exchanger surface by the camera;
identifying in the image at least two first features of the heat exchanger surface, where respective positions of the at least two first features on the heat exchanger surface are known;
identifying in the image a plurality of second features of the heat exchanger surface;
determining respective positions of the plurality of second features on the heat exchanger surface based upon the respective positions of the at least two first features on the heat exchanger surface;
estimating a position of the camera on the heat exchanger surface based on a predetermined positional relationship between the camera and the image;
measuring distortion in the image; and
adjusting the estimated position of the camera based on the measured distortion.
